(19) United States
(12) Patent Application Publication
(10) Pub. No.: US 2024/0267808 A1
(43) Pub. Date: Aug. 8, 2024

(54) TECHNIQUES FOR NON-TERRESTRIAL NETWORK MOBILITY WITH A MOVING CELL

(71) Applicant: QUALCOMM Incorporated, San Diego, CA (US)

(72) Inventors: Lianghai Ji, San Diego, CA (US); Jun Ma, San Diego, CA (US); Liangping Ma, San Diego, CA (US); Mohamad Sayed Hassan, Paris (FR); Karthik Anantha Swamy, La Jolla, CA (US)

(21) Appl. No.: 18/166,411

(22) Filed: Feb. 8, 2023

(51) Int. Cl. H04W 36/08; H04W 36/00

(52) U.S. Cl. CPC H04W 36/08; H04W 36/0005; H04W 84/06

(57) ABSTRACT

Methods, systems, and devices for wireless communications are described. A UE operating in an NTN may receive an indication of coverage information for a first cell associated with the NTN. The coverage information may indicate a coverage area supported by the first cell for wireless communications. The UE may transmit, based on location information of the UE and the coverage information, a message indicating a timing information associated with a measurement-based handover for the UE from the first cell to a second cell associated with the non-terrestrial network. For example, the message may include a recommendation for the UE to perform a non-measurement-based handover or an indication that the UE cannot complete the measurement-based handover before leaving the coverage area of the first cell.

### INTRODUCTION

The following relates to wireless communications, including mobility in a non-terrestrial network (NTN) with a moving cell.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communications at a UE is described. The method may include receiving an indication of coverage information for a first cell associated with a NTN, the coverage information indicating a coverage area supported by the first cell for wireless communications and transmitting, based on location information of the UE and the coverage information, a message indicating a timing information associated with a measurement-based handover for the UE from the first cell to a second cell associated with the NTN.

An apparatus for wireless communications at a UE is described. The apparatus may include a processor and memory coupled with the processor. The processor may be configured to receive an indication of coverage information for a first cell associated with a NTN, the coverage information indicating a coverage area supported by the first cell for wireless communications and transmit, based on location information of the UE and the coverage information, a message indicating a timing information associated with a measurement-based handover for the UE from the first cell to a second cell associated with the NTN.

Another apparatus for wireless communications at a UE is described. The apparatus may include means for receiving an indication of coverage information for a first cell associated with a NTN, the coverage information indicating a coverage area supported by the first cell for wireless communications and means for transmitting, based on location information of the UE and the coverage information, a message indicating a timing information associated with a measurement-based handover for the UE from the first cell to a second cell associated with the NTN.

A non-transitory computer-readable medium storing code for wireless communications at a UE is described. The code may include instructions executable by a processor to receive an indication of coverage information for a first cell associated with a NTN, the coverage information indicating a coverage area supported by the first cell for wireless communications and transmit, based on location information of the UE and the coverage information, a message indicating a timing information associated with a measurement-based handover for the UE from the first cell to a second cell associated with the NTN.

Some examples of the method, apparatuses, and non-transitory computer-readable medium described herein may further include operations, features, means, or instructions for receiving, in response to the message indicating the timing information, control signaling associated with a non-measurement-based handover for the UE from the first cell to the second cell.

Some examples of the method, apparatuses, and non-transitory computer-readable medium described herein may further include operations, features, means, or instructions for performing the non-measurement-based handover from the first cell to the second cell based on the control signaling.

Some examples of the method, apparatuses, and non-transitory computer-readable medium described herein may further include operations, features, means, or instructions for receiving, from the NTN, a configuration to transmit the message indicating the timing information, the message indicating the timing information being transmitted in response to the configuration received from the NTN.

In some examples of the method, apparatuses, and non-transitory computer-readable medium described herein, the configuration may be associated with one of a satellite type or a non-terrestrial cell type of the first cell or the second cell, or both.

Some examples of the method, apparatuses, and non-transitory computer-readable medium described herein may further include operations, features, means, or instructions for receiving an indication of a timing threshold, the message being transmitted based on a time duration associated with the UE remaining within the coverage area supported by the first cell failing to satisfy the timing threshold.

In some examples of the method, apparatuses, and non-transitory computer-readable medium described herein, the time duration associated with the UE remaining within the coverage area supported by the first cell may be based on the location information of the UE, an ephemeris of a satellite associated with the first cell, a reference location of the first cell, a radius of the first cell, the coverage information, or any combination thereof.

In some examples of the method, apparatuses, and non-transitory computer-readable medium described herein, the message may be transmitted based on a first time duration associated with the UE being within the coverage area supported by the first cell being smaller than a second time duration, the second time duration associated with UE characteristics for the measurement-based handover.

In some examples of the method, apparatuses, and non-transitory computer-readable medium described herein, the second time duration associated with the UE characteristics may be based on a quantity or a characteristic of antennas of the UE, a round-trip-time between the UE and the first cell or the second cell, or any combination thereof.

Some examples of the method, apparatuses, and non-transitory computer-readable medium described herein may further include operations, features, means, or instructions for receiving an indication of one or more parameters associated with the measurement-based handover for the UE, the message being transmitted based on a first time duration associated with the UE being within the coverage area supported by the first cell being smaller than a second time duration associated with the UE performing the measurement-based handover, the second time duration being based on any combination of the one or more parameters associated with the measurement-based handover or UE characteristics associated with the measurement-based handover, or both.

In some examples of the method, apparatuses, and non-transitory computer-readable medium described herein, the one or more parameters associated with the measurement-based handover include a measurement periodicity, a measurement gap repetition period, or both.

In some examples of the method, apparatuses, and non-transitory computer-readable medium described herein, the indication of the one or more parameters may be received via a system information block (SIB), a Radio Resource Control (RRC) message, a medium access control (MAC) message, or any combination thereof.

Some examples of the method, apparatuses, and non-transitory computer-readable medium described herein may further include operations, features, means, or instructions for receiving an indication of parameters to perform a measurement for the measurement-based handover from the first cell to the second cell, the one or more parameters associated with the measurement-based handover being based on the parameters to perform the measurement for the measurement-based handover.

In some examples of the method, apparatuses, and non-transitory computer-readable medium described herein, transmitting the message may include operations, features, means, or instructions for transmitting the message indicating a recommendation for the UE to perform one of the measurement-based handover or a non-measurement-based handover, whether the UE can complete the measurement-based handover before leaving the coverage area of the first cell, an estimated time duration associated with the UE remaining in the coverage area of the first cell, a position of the UE, or any combination thereof.

Some examples of the method, apparatuses, and non-transitory computer-readable medium described herein may further include operations, features, means, or instructions for receiving, from the NTN, a configuration indicating one or more parameters for the timing information or a granularity of the timing information, the timing information based on the configuration received from the NTN.

In some examples of the method, apparatuses, and non-transitory computer-readable medium described herein, the message may be transmitted via a third message or a fifth message of a random access procedure, an uplink message after the random access procedure, a random access preamble, a random access occasion, or any combination thereof.

A method for wireless communications at a UE is described. The method may include receiving an indication of coverage information for a first cell associated with a NTN, the coverage information indicating a coverage area supported by the first cell for wireless communications and receiving, after a timing associated with time resources allocated for transmission of an indication of a time estimation associated with a connection between the first cell and the UE, a handover command associated with a measurement-based handover for the UE.

An apparatus for wireless communications at a UE is described. The apparatus may include a processor and memory coupled with the processor. The processor may be configured to receive an indication of coverage information for a first cell associated with a NTN, the coverage information indicating a coverage area supported by the first cell for wireless communications and receive, after a timing associated with time resources allocated for transmission of an indication of a time estimation associated with a connection between the first cell and the UE, a handover command associated with a measurement-based handover for the UE.

Another apparatus for wireless communications at a UE is described. The apparatus may include means for receiving an indication of coverage information for a first cell associated with a NTN, the coverage information indicating a coverage area supported by the first cell for wireless communications and means for receiving, after a timing associated with time resources allocated for transmission of an indication of a time estimation associated with a connection between the first cell and the UE, a handover command associated with a measurement-based handover for the UE.

A non-transitory computer-readable medium storing code for wireless communications at a UE is described. The code may include instructions executable by a processor to receive an indication of coverage information for a first cell associated with a NTN, the coverage information indicating a coverage area supported by the first cell for wireless communications and receive, after a timing associated with time resources allocated for transmission of an indication of a time estimation associated with a connection between the first cell and the UE, a handover command associated with a measurement-based handover for the UE.

Some examples of the method, apparatuses, and non-transitory computer-readable medium described herein may further include operations, features, means, or instructions for transmitting, based on location information of the UE and the coverage information, a message indicating timing information associated with the measurement-based handover from the first cell to a second cell associated with the NTN.

In some examples of the method, apparatuses, and non-transitory computer-readable medium described herein, the message indicates that the UE can perform the measurement-based handover before leaving the coverage area supported by the first cell.

Some examples of the method, apparatuses, and non-transitory computer-readable medium described herein may further include operations, features, means, or instructions for performing the measurement-based handover from the first cell to a second cell based on the handover command.

Some examples of the method, apparatuses, and non-transitory computer-readable medium described herein may further include operations, features, means, or instructions for receiving an indication of a timing threshold, the handover command being received based on a time duration associated with the UE remaining within the coverage area supported by the first cell satisfying the timing threshold.

In some examples of the method, apparatuses, and non-transitory computer-readable medium described herein, the time duration associated with the UE remaining within the coverage area supported by the first cell may be based on location information of the UE, an ephemeris of a satellite associated with of the first cell, a reference location of the first cell, a radius of the first cell, the coverage information, or any combination thereof.

In some examples of the method, apparatuses, and non-transitory computer-readable medium described herein, the handover command may be received based on a first time duration associated with the UE being within the coverage area supported by the first cell being larger than a second time duration associated with UE characteristics for the measurement-based handover.

In some examples of the method, apparatuses, and non-transitory computer-readable medium described herein, the second time duration associated with the UE characteristics may be based on a quantity or a characteristic of antennas of the UE, a round-trip-time between the UE and the first cell or a second cell associated with the handover command, or any combination thereof.

Some examples of the method, apparatuses, and non-transitory computer-readable medium described herein may further include operations, features, means, or instructions for receiving an indication of one or more parameters associated with the measurement-based handover, the handover command being received based on a first time duration associated with the UE being within the coverage area supported by the first cell being larger than a second time duration associated with the UE performing the measurement-based handover, the second time duration based on any combination of the one or more parameters associated with the measurement-based handover or UE characteristics associated with the measurement-based handover, or both.

A method for wireless communications at a network device is described. The method may include outputting an indication of coverage information for a first cell associated with a NTN, the coverage information indicating a coverage area supported by the first cell for wireless communications and monitoring for a message indicating a timing information associated with a measurement-based handover from the first cell to a second cell associated with the NTN.

An apparatus for wireless communications at a network device is described. The apparatus may include a processor and memory coupled with the processor. The processor may be configured to output an indication of coverage information for a first cell associated with a NTN, the coverage information indicating a coverage area supported by the first cell for wireless communications and monitor for a message indicating a timing information associated with a measurement-based handover from the first cell to a second cell associated with the NTN.

Another apparatus for wireless communications at a network device is described. The apparatus may include means for outputting an indication of coverage information for a first cell associated with a NTN, the coverage information indicating a coverage area supported by the first cell for wireless communications and means for monitoring for a message indicating a timing information associated with a measurement-based handover from the first cell to a second cell associated with the NTN.

A non-transitory computer-readable medium storing code for wireless communications at a network device is described. The code may include instructions executable by a processor to output an indication of coverage information for a first cell associated with a NTN, the coverage information indicating a coverage area supported by the first cell for wireless communications and monitor for a message indicating a timing information associated with a measurement-based handover from the first cell to a second cell associated with the NTN.

In some examples of the method, apparatuses, and non-transitory computer-readable medium described herein, monitoring for the message may include operations, features, means, or instructions for obtaining the message indicating the timing information associated with the measurement-based handover from the first cell to the second cell associated with the NTN.

In some examples of the method, apparatuses, and non-transitory computer-readable medium described herein, outputting, in response to the message that indicates the timing information, control signaling associated with a non-measurement-based handover from the first cell to the second cell.

Some examples of the method, apparatuses, and non-transitory computer-readable medium described herein may further include operations, features, means, or instructions for outputting a configuration for transmitting the message indicating the timing information, the message indicating the timing information being received based on the configuration.

In some examples of the method, apparatuses, and non-transitory computer-readable medium described herein, the configuration may be associated with one of a satellite type or a non-terrestrial cell type of the first cell or the second cell, or both.

Some examples of the method, apparatuses, and non-transitory computer-readable medium described herein may further include operations, features, means, or instructions for outputting an indication of a timing threshold, the message indicating that a time duration associated with remaining within the coverage area supported by the first cell fails to satisfy the timing threshold.

In some examples of the method, apparatuses, and non-transitory computer-readable medium described herein, the message indicates that a first time duration associated with being within the coverage area supported by the first cell may be smaller than a second time duration, the second time duration associated with wireless device characteristics for the measurement-based handover.

Some examples of the method, apparatuses, and non-transitory computer-readable medium described herein may further include operations, features, means, or instructions for outputting an indication of one or more parameters associated with the measurement-based handover, the message indicating that a first time duration associated with being within the coverage area supported by the first cell may be smaller than a second time duration associated with a wireless device performing the measurement-based handover, the second time duration being based on any of the one or more parameters associated with the measurement-based handover, wireless device characteristics associated with the measurement-based handover, or both.

In some examples of the method, apparatuses, and non-transitory computer-readable medium described herein, the one or more parameters associated with the measurement-based handover include a measurement periodicity, a measurement gap repetition period, or both.

In some examples of the method, apparatuses, and non-transitory computer-readable medium described herein, the message indicates a recommendation for the measurement-based handover or a non-measurement-based handover, that a wireless device cannot complete the measurement-based handover prior leaving the coverage area of the first cell, an estimated time duration associated with the wireless device remaining in the coverage area of the first cell, a position of the wireless device, or any combination thereof.

Some examples of the method, apparatuses, and non-transitory computer-readable medium described herein may further include operations, features, means, or instructions for outputting a configuration indicating one or more parameters for the timing information or a granularity of the timing information, the timing information being based on the configuration.

In some examples of the method, apparatuses, and non-transitory computer-readable medium described herein, the message may be obtained via a third message or a fifth message of a random access procedure, an uplink message after the random access procedure, a random access preamble, a random access occasion, or any combination thereof.

In some examples of the method, apparatuses, and non-transitory computer-readable medium described herein, the message indicates that a wireless device can perform the measurement-based handover before leaving the coverage area supported by the first cell.

In some examples of the method, apparatuses, and non-transitory computer-readable medium described herein, the message indicates that a wireless device cannot perform the measurement-based handover before leaving the coverage area supported by the first cell.

In some examples of the method, apparatuses, and non-transitory computer-readable medium described herein, outputting, after a timing associated with time resources allocated for transmission of an indication of a time estimation associated with a connection between the first cell and a wireless device, a handover command associated with the measurement-based handover for the wireless device.

In some examples of the method, apparatuses, and non-transitory computer-readable medium described herein, the indication of the coverage information may be transmitted via a SIB, an RRC message, a MAC message, or any combination thereof.

Some examples of the method, apparatuses, and non-transitory computer-readable medium described herein may further include operations, features, means, or instructions for outputting an indication of one or more parameters to perform a measurement for the measurement-based handover from the first cell to the second cell, the message received in response to the indication of the one or more parameters.

Some examples of the method, apparatuses, and non-transitory computer-readable medium described herein may further include operations, features, means, or instructions for obtaining a second message indicating a recommendation to perform the measurement-based handover or a non-measurement-based handover, an indication of whether the measurement-based handover can be completed prior to a wireless device leaving the coverage area of the first cell, an estimated time duration associated with the wireless device remaining in the coverage area of the first cell, a position of the wireless device, or any combination thereof.

### BRIEF DESCRIPTION OF THE DRAWINGS

FIG. 1 illustrates an example of a wireless communications system that supports techniques for NTN mobility with a moving cell in accordance with one or more aspects of the present disclosure.

FIG. 2 illustrates an example of a network architecture that supports techniques for NTN mobility with a moving cell in accordance with one or more aspects of the present disclosure.

FIG. 3 illustrates an example of a wireless communications system that supports techniques for NTN mobility with a moving cell in accordance with one or more aspects of the present disclosure.

FIG. 4 illustrates an example of a moving cell scenario that supports techniques for NTN mobility with a moving cell in accordance with one or more aspects of the present disclosure.

FIG. 5 illustrates an example of a process flow that supports techniques for NTN mobility with a moving cell in accordance with one or more aspects of the present disclosure.

FIGS. 6 and 7 illustrate block diagrams of devices that support techniques for NTN mobility with a moving cell in accordance with one or more aspects of the present disclosure.

FIG. 8 illustrates a block diagram of a communications manager that supports techniques for NTN mobility with a moving cell in accordance with one or more aspects of the present disclosure.

FIG. 9 illustrates a diagram of a system including a device that supports techniques for NTN mobility with a moving cell in accordance with one or more aspects of the present disclosure.

FIGS. 10 and 11 illustrate block diagrams of devices that support techniques for NTN mobility with a moving cell in accordance with one or more aspects of the present disclosure.

FIG. 12 illustrates a block diagram of a communications manager that supports techniques for NTN mobility with a moving cell in accordance with one or more aspects of the present disclosure.

FIG. 13 illustrates a diagram of a system including a device that supports techniques for NTN mobility with a moving cell in accordance with one or more aspects of the present disclosure.

FIGS. 14 through 18 illustrate flowcharts showing methods that support techniques for NTN mobility with a moving cell in accordance with one or more aspects of the present disclosure.

### DETAILED DESCRIPTION

Some wireless communications systems may include non-terrestrial entities, such as aircraft, UAVs, zeppelins, satellites, etc. In some cases, wireless devices (e.g., UEs) may be able to communicate with non-terrestrial entities when the wireless devices are out of cellular coverage of terrestrial network entities, such as base stations or other network entities. In such cases, the UEs may be able to connect to non-terrestrial entities so that the non-terrestrial entities may relay wireless communications to and from the UEs. For the purposes of the present disclosure, different types of non-terrestrial entities may be referred to as non-terrestrial relay nodes (e.g., aircrafts, UAVs, etc.) or NTN nodes (e.g., satellites). Non-terrestrial relay nodes may act as UEs, integrated access and backhaul (IAB) nodes, network entities, or any combination thereof, and may be configured to relay communications between wireless devices, such as between UEs and terrestrial entities, other non-terrestrial entities, or both. NTN nodes may include non-terrestrial entities, such as satellites, which are associated with an NTN and which may be communicatively coupled to terrestrial entities such as NTN gateways. An NTN may support both measurement-based handovers and non-measurement-based handovers. For a measurement-based handover, a wireless device accessing a cell or a coverage area supported by the NTN, such as a UE, may perform measurements on different cells or beams, such as cells or beams transmitted by another non-terrestrial entity, in order to reselect another beam for the handover. For a non-measurement-based handover, the UE or the NTN may select a new cell or beam for the UE based on, for example, positioning information of the UE.

A non-terrestrial entity may move, such as a satellite moving in space. Some wireless communications systems may provide a quasi-Earth fixed beam or cell scenario, where a footprint of a beam or cell remains static on the Earth for a certain amount of time while the non-terrestrial entity moves. For example, the non-terrestrial entity may adjust the angle of projection of the footprint, such that the beam or cell footprint covers a same place on the Earth for a period of time. Additionally, or alternatively, some wireless communications systems may support a Earth-moving beam or cell scenario, where the footprint of the beam or cell moves on the Earth together with the non-terrestrial entity.

With an Earth-moving cell, network devices at different positions of the cell footprint may move out of, exit, or leave cell coverage at different timings. For example, a UE that accesses the cell while in the middle of the cell coverage may be connected for longer than a UE that accesses the cell near an approaching cell edge, or when the cell is fading away. If a UE accesses the cell while the cell is fading away, the UE may become out of coverage prior to completing a measurement-based handover, which may reduce the robustness for supporting mobility. However, the non-terrestrial entity may still configure the UE with measurement-based events and configurations for measurement-based handovers, despite the UE not being able to complete a measurement-based handover prior to leaving the cell coverage, which may waste resources to configure the UE with the measurement-based events and configurations that are not used. In some examples, the UE may be considered able to complete the handover procedure if the UE initiates a measurement-based handover and is handed over to another cell before leaving the cell coverage of the first cell. If the UE is not handed over to the other cell prior to leaving the cell coverage of the first cell, the UE may not be considered to have completed the measurement-based handover procedure.

Accordingly, one or more aspects of the present disclosure are directed to indicating timing information related to whether a UE can complete a measurement-based handover prior to exiting the coverage area of a cell in an NTN or prior to the coverage area of the cell in the NTN moving away from the UE such that the UE is not within the coverage area of the cell. For example, when a UE accesses a cell, the UE may transmit an indication to a network node or network device of the NTN. The indication may assist the NTN in determining a scheme to support NTN mobility for the UE. For example, the NTN may determine whether there is sufficient time to perform a measurement-based handover for the UE before the UE exits the coverage area of the cell. In some examples, the UE may transmit the indication if the UE does not have sufficient time to perform a measurement-based handover. If the UE transmits the indication, according to one aspect, the UE may be configured for a non-measurement-based handover in response. If the UE has sufficient time to perform a measurement-based handover prior to leaving the coverage area of the cell, the NTN may configure the UE for a measurement-based handover. In some examples, the UE may not transmit an indication if the UE has sufficient time to perform a measurement-based handover, or the UE may transmit an indication that the UE does have sufficient time to perform the measurement-based handover.

The UE may determine whether the UE can complete the measurement-based handover before leaving the coverage area of the cell based on a configuration received from the NTN. For example, the NTN may send a timing threshold to the UE, and the UE may determine whether to transmit the indication based on the timing threshold and a UE-estimated time duration before the UE leaves the serving cell's coverage. In some examples, the UE may estimate a first time duration until the UE moves out of the cell and a second time duration associated with performing a measurement-based handover, and the UE may transmit the indication if the first time duration exceeds the second time duration (e.g., the UE estimates the measurement-based handover can be performed prior to leaving the cell). Some additional techniques for configuring estimations or determining whether the measurement-based handover can be performed in time are described herein. The NTN may configure the UE with either a measurement-based handover if the UE can perform the measurement-based handover in time or a non-measurement-based handover if the UE cannot perform the measurement-based handover in time, which may improve mobility robustness. Additionally, the NTN may not configure the UE with measurement-based events and configurations if the UE cannot perform the measurement-based handover in time, which may increase resource availability and reduce overhead.

Aspects of the disclosure are initially described in the context of wireless communications systems. Aspects of the disclosure are further illustrated by and described with reference to apparatus diagrams, system diagrams, and flowcharts that relate to techniques for NTN mobility with a moving cell.

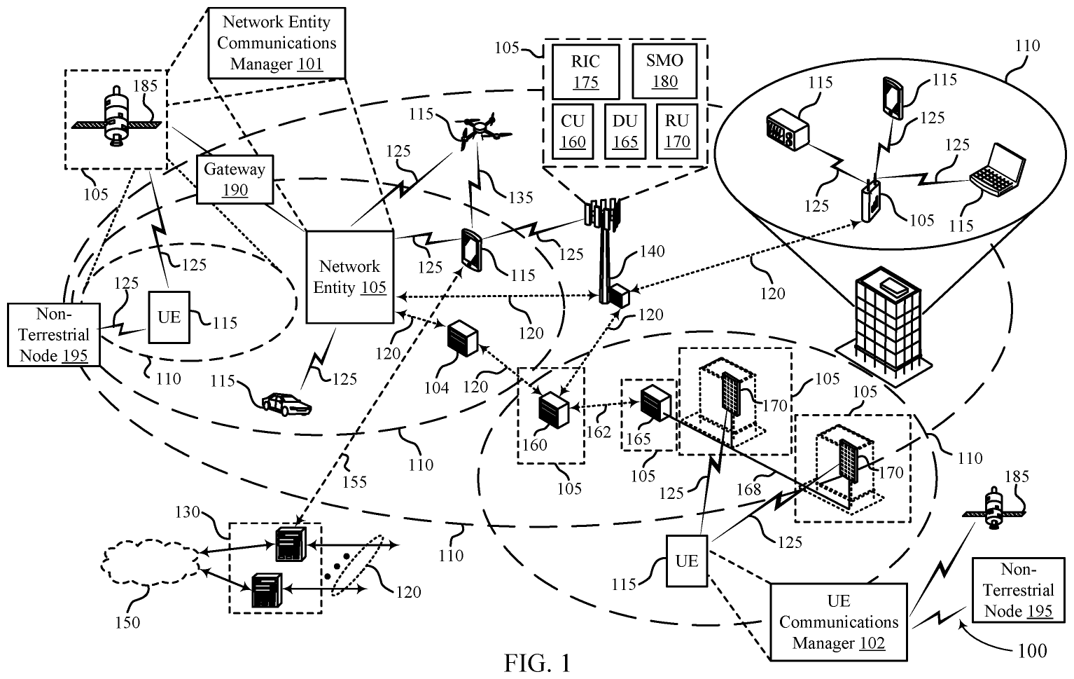

FIG. 1 illustrates an example of a wireless communications system 100 that supports techniques for NTN mobility with a moving cell in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an IAB network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for NTN mobility with a moving cell as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a cell footprint, a coverage area 110, or a portion of a coverage area 110 (e.g., a sector) over which the logical communication entity operates (e.g., within which wireless communications are supported for devices such as UEs 115). Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. For example, a satellite may be an example of a network entity 105, or aspects of the network entity 105, and may support or provide a moving cell or a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support NTN communications between network nodes of the wireless communications system 100. For example, the wireless communications system 100 may be an example of an NTN that supports communications between NTN nodes and terrestrial network nodes. For instance, as described herein, a network entity 105 may refer to a terrestrial communication device (such as a base station 140) or a non-terrestrial communication device (such as a satellite 185, a balloon, a drone, a non-terrestrial node 195, a high-altitude platform (HAP) station, or another non-terrestrial device). A NTN network entity 105 may be connected to (e.g., communicate with) a terrestrial network entity 105 via a gateway 190. In some examples, a NTN network entity 105 may correspond to a first cell type (e.g., an NTN cell type), and a terrestrial network entity 105 may correspond to a second cell type (e.g., a terrestrial cell type) different from the first cell type.

In some examples, a NTN network entity 105 may provide coverage to areas in which a terrestrial network entity 105 may be unavailable. A channel corresponding to the NTN network entity 105 may be characterized with strong line of sight conditions, as a signal provided by the NTN network entity 105 may be reflected at the sky (e.g., as opposed to a signal corresponding to a terrestrial network entity 105 which may travel over a ground surface). A footprint of a beam radiated from the NTN network entity 105 may have a relatively clear boundary (e.g., as compared to terrestrial network entity 105 beam boundaries), and a UE 115 may be likely to operate within a single beam serving area (e.g., except in cases where a UE 115 is located at the boundary between two serving areas). In some examples, a serving area for a beam corresponding to the NTN network entity 105 may be larger than a serving area for a beam corresponding to a terrestrial network entity 105.

An NTN network entity 105, such as a satellite 185, may move over time and support various coverage scenarios. For example, the NTN network entity 105 may support a moving cell or beam coverage scenario in which the cell footprint or beam footprint moves together with the satellite 185. Alternatively, the NTN network entity 105 may support a quasi-Earth fixed cell or beam coverage scenario in which the cell footprint of beam footprint remains static for a period of time as the NTN network entity 105 moves through space.

Additionally, or alternatively, the wireless communications system 100 may support one or more non-terrestrial nodes 195. For the purposes of the present disclosure, non-terrestrial nodes 195 may include, but are not limited to, aircraft, UAVs, drones, HAPs, and the like. For example, as shown in FIG. 1, a UE 115 may be communicatively coupled to a satellite 185 (e.g., NTN node), a non-terrestrial node 195, or both, via one or more communication links 125.

A network entity 105 may include a network entity communications manager 101 to manage communications between the network entity 105 and other devices in the wireless communications system 100. In a similar manner, a UE communications manager 102 may manage communications between a UE 115 and other devices in the wireless communications system 100.

An NTN may support both measurement-based handovers and non-measurement-based handovers. For a measurement-based handover, a wireless device accessing a cell provided by the NTN, such as a UE 115, may perform measurements on different cells or beams, such as cells or beams transmitted by another non-terrestrial entity, in order to reselect another beam for the handover. In some examples, the UE 115 may perform measurements such as reference signal received power (RSRP) measurements, channel quality information (CQI) measurements, SNR measurements, among others. For a non-measurement-based handover, the UE 115 or the NTN may select a new cell or beam for the UE 115 without the UE 115 providing a measurement report. In some examples, a non-measurement-based handover may be based on, for example, positioning information of the UE 115. In some examples, a conditional handover may be an example of a non-measurement-based handover or a measurement-based handover, where the UE 115 may perform a handover from a first cell to a second cell when one or more configured conditions are satisfied, such as a measurement of the first cell satisfying a threshold (e.g., failing to exceed the threshold).

In some examples, a non-terrestrial entity which provides a cell may move, such as a satellite moving in space. Some wireless communications systems may provide a quasi-Earth fixed beam or cell scenario, where a footprint of a beam or cell, such as a coverage area of the beam or the cell, remains static on the Earth for a certain amount of time while the non-terrestrial entity moves. For example, the non-terrestrial entity may adjust the angle of projection of the footprint, such that the beam or cell footprint covers a same place or area on the Earth for a period of time. Additionally, or alternatively, some wireless communications systems may support an Earth-moving or an Earth-moving beam or cell scenario, where the footprint of the beam or cell moves on the Earth together with the non-terrestrial entity.

With an Earth-moving cell scenario, network devices at different positions of the cell footprint may move out of cell coverage at different timings. For example, a UE 115 that accesses the cell while in the middle of the cell coverage may be connected for a longer period of time than a UE 115 that accesses the cell near an approaching cell edge, or when the cell is fading away. For example, the UE 115 may not move, but the cell (e.g., provided by a satellite or an NTN node) may move with the movement of the cell provider. As such, the UE 115 which is closer to an edge of a cell which is approaching the UE 115 may move, exit, leave, or otherwise be out of coverage of the cell in a shorter time duration than another UE 115 which is farther from the edge of the approaching edge of the cell. In some examples, the UE 115 may be considered to enter an area or a region which is not covered by the cell or is covered by a different cell. If a UE 115 accesses the cell while the cell is fading away, the UE 115 may become out of coverage prior to completing a measurement-based handover. However, the non-terrestrial entity may still configure the UE 115 with measurement-based events and configurations for measurement-based handovers, despite the UE 115 not being able to complete a measurement-based handover prior to leaving, exiting, or moving out of the cell coverage.

Accordingly, one or more aspects of the present disclosure are directed to indicating timing information related to whether a UE 115 can complete a measurement-based handover prior to exiting the coverage area of a cell in an NTN. For example, when a UE 115 accesses a cell, the UE 115 may transmit an indication to the NTN, the indication assisting the NTN in determining a scheme to support NTN mobility for the UE 115. For example, the NTN may determine whether there is sufficient time to perform a measurement-based handover for the UE 115 before the UE 115 exits the coverage area of the cell. In some examples, the UE 115 may transmit the indication if the UE 115 does not have sufficient time to perform a measurement-based handover. If the UE 115 transmits the indication, the UE 115 may be configured for a non-measurement-based handover in response. If the UE 115 has sufficient time to perform a measurement-based handover prior to leave the coverage area of the cell, the NTN may configure the UE 115 for a measurement-based handover. In some examples, the UE 115 may not transmit an indication if the UE 115 has sufficient time to perform a measurement-based handover, or the UE 115 may transmit an indication that the UE 115 does have sufficient time to perform the measurement-based handover.

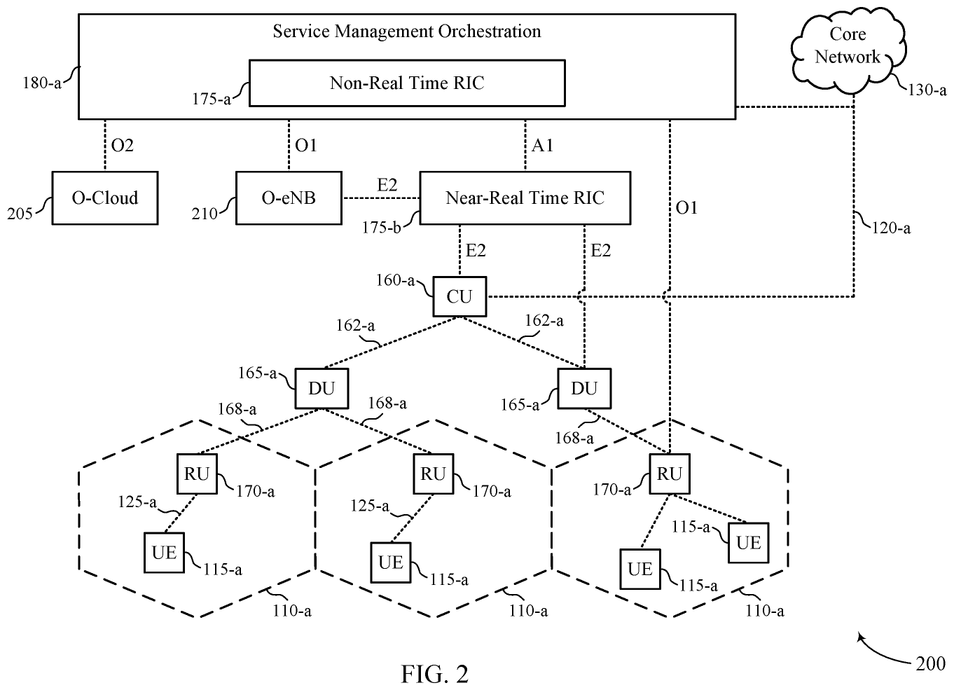

FIG. 2 illustrates an example of a network architecture 200 (e.g., a disaggregated base station architecture, a disaggregated RAN architecture) that supports techniques for NTN mobility with a moving cell in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

One or more aspects of the present disclosure are directed to indicating timing information related to whether a UE 115, such as the UE 115-a, can complete a measurement-based handover prior to exiting the coverage area of a cell in an NTN. For example, an RU 170-a may be an example of, or be an example of aspects of, an NTN node or an NTN device, such as a satellite, which may provide a cell for the UE 115-a. When the UE 115-a accesses a cell, the UE 115-a may transmit an indication to the NTN that assists the NTN in determining a scheme to support NTN mobility for the UE 115-a. In some examples, a CU 160-a or a DU 165-a may determine the scheme to support NTN mobility for the UE 115-a. For example, the NTN, such as via the CU 160-a or the DU 165-a, may determine whether there is sufficient time to perform a measurement-based handover for the UE 115-a before the UE 115-a exits the coverage area of the cell. In some examples, the UE 115-a may transmit the indication if the UE 115-a does not have sufficient time to perform a measurement-based handover. If the UE 115-a transmits the indication, the UE 115-a may be configured for a non-measurement-based handover in response. For example, the RU 170-a may transmit control signaling to configure the UE 115-a for the non-measurement-based handover. If the UE 115-a has sufficient time to perform a measurement-based handover prior to leave the coverage area of the cell, the NTN may configure the UE 115-a for a measurement-based handover. For example, the RU 170-a may transmit control signaling to configure the UE 115-a for the measurement-based handover. In some examples, the UE 115-a may not transmit an indication if the UE 115-a has sufficient time to perform a measurement-based handover, or the UE 115-a may transmit an indication that the UE 115-a does have sufficient time to perform the measurement-based handover.

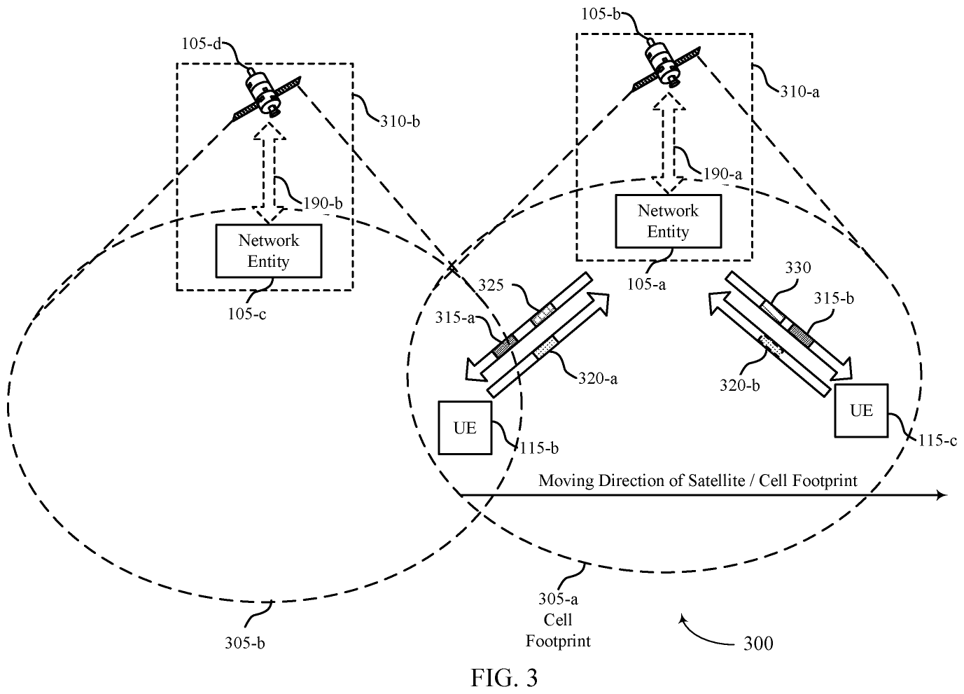

FIG. 3 illustrates an example of a wireless communications system 300 that supports techniques for NTN mobility with a moving cell in accordance with one or more aspects of the present disclosure. The wireless communications system 300 may implement aspects of, or include aspects of, a wireless communications system 100 or a network architecture 200, or both, as described with reference to FIGS. 1 and 2. In some examples, the wireless communications system 300 may be an example of an NTN.

The wireless communications system 300 may include one or more NTN nodes 310, one or more non-terrestrial network entities 105-b, one or more UEs 115, or one or more terrestrial entities 105-a, or any combination thereof. An NTN node 310, such as an NTN node 310-a, may include one or more of, or aspects of one or more of, a satellite, a network entity 105, such as a terrestrial network entity 105-a or a non-terrestrial network entity 105-b, or both, a network device, or any combination thereof, each of which may be an example of a corresponding device as described with reference to FIGS. 1 and 2. Similarly, an NTN node 310-b may include one or more of, or aspects of one or more of, a satellite, a network entity 105, such as a terrestrial network entity 105-c or a non-terrestrial network entity 105-d, or both, a network device, or any combination thereof, each of which may be an example of a corresponding device as described with reference to FIGS. 1 and 2. The wireless communications system 300 may include a UE 115-b and a UE 115-c, which may each be an example of a UE 115 as described with reference to FIGS. 1 and 2. A terrestrial network entity 105-a may be an example of a network node or a network entity 105 as described with reference to FIG. 1.

In some examples, the NTN node 310-a may include the terrestrial network entity 105-a and the non-terrestrial network entity 105-b. In some examples, the terrestrial network entity 105-a and the non-terrestrial network entity 105-b may communicate, such as via a gateway 190-a. The terrestrial network entity 105-c and the non-terrestrial network entity 105-d may also communicate via a gateway, such as a gateway 190-b. The gateway 190-a and the gateway 190-b may each be an example of a gateway 190 as described with reference to FIG. 1. In some examples, a UE 115 is described to communicate with the NTN node 310-a. A UE 115 communicating with the NTN node 310-a may correspond to the UE 115 communicating with the terrestrial network entity 105-a, the non-terrestrial network entity 105-b, a satellite, a network device, or any combination thereof.

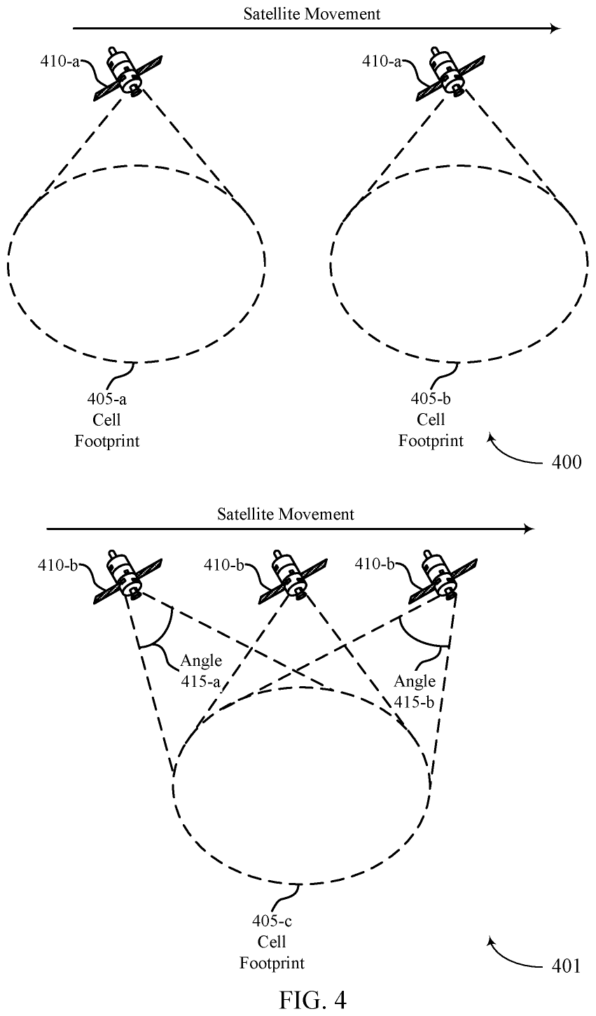

In some examples, the wireless communications system 300 may implement aspects of an Earth-moving cell scheme. In an Earth-moving cell scheme, a satellite, such as the non-terrestrial network entity 105-b, may project a cell footprint 305-a onto the Earth, and the cell footprint 305-a may move with the satellite. For example, if the satellite moves from east to west, the cell footprint 305-a projected onto the Earth may move with the satellite from east to west. In another example, in an Earth-moving cell scheme, the satellite antenna may be non-steerable. An example of an Earth-moving cell scheme is described in more detail with reference to FIG. 4.

In the Earth-moving cell scheme, UEs 115 at different positions may move out of cell coverage at different timings. For example, a UE 115-b may be near an edge of the cell footprint 305-a that is approaching the UE 115-b based on the moving direction of the satellite. A UE 115-c may be closer to an edge of a cell footprint 305-a that is moving away from the UE 115-c based on the moving direction of the satellite. Therefore, the UE 115-b may leave the cell footprint 305-a before the UE 115-c, or the UE 115-c may remain in the cell coverage longer than the UE 115-b.

If a UE 115 accesses the cell footprint 305-a when the UE 115 is at the beginning of the cell, the NTN node 310-a may configure the UE 115 with measurement configurations for mobility support. For example, if the UE 115-c accesses the cell provided by the NTN node 310-a, compared to the UE 115-b, the UE 115-c may be in the cell footprint 305-a for a longer duration based on the position of the UE 115-c within the cell footprint 305-a and the moving direction of the satellite. In some examples, the NTN node 310-a may configure the UE 115-c with measurement configurations, such as measurement events, for mobility support, such as a measurement-based handover. In some examples, the UE 115-c may be configured to perform a measurement-based handover to be handed over to a second cell provided by another NTN node 310, such a cell with a cell footprint 305-b provided by the NTN node 310-b, another cell provided by the NTN node 310-a, a network entity 105, or another wireless device of the wireless communications system 300.

However, if a UE 115 accesses the cell footprint 305-a when the cell is fading away, the UE 115 may become out of the serving cell's coverage before the measurement-based handover executes. For example, if the UE 115-b joins the cell provided by the satellite while near the edge of the cell footprint 305-a that is approaching the UE 115-b, the UE 115-b may not have sufficient time to perform a measurement-based handover before leaving the cell footprint 305-a. The NTN may use other information to support mobility for the UE 115-b, such as using a location of the UE 115-b to hand the UE 115-b to another neighbor cell.

Performing a measurement-based handover procedure may take a duration before the measurement-based handover is executed and a UE 115 is handed over. In some examples, the duration may be based on a signaling latency for transmitting the measurement configuration or the measurement report, or both. Additionally, or alternatively, the duration may be based on a time lag for the UE 115 to detect that a measurement reporting event has been triggered. In some examples, a very small aperture terminal (VSAT) type of NTN device may use more time (e.g., around 1 second) to mechanically tune an antenna, antenna panel, antenna array, or a dish toward a neighbor cell for measurements.

Based on the time it takes to perform a measurement-based handover and a duration of time until the UE 115-b leaves the cell footprint, if the UE 115-b is configured with measurement-based events, the UE 115-b may not even have the opportunity to perform the measurement-based handover before the UE 115-b leaves the cell footprint. As such, configuring the UE 115-b with measurement-based events may waste resources.

The wireless communications system 300 may support or implement techniques for NTN mobility to efficiently perform a measurement-based handover or a non-measurement-based handover for a UE 115. For example, a UE 115 may be configured to transmit an indication to the NTN node 310-a, where the indication assists the NTN node in determining a proper scheme to support NTN mobility for the UE 115, such as in determining if there is sufficient time to perform a measurement-based handover.

In some examples, the UE 115 may transmit a message 320 indicating timing information based on a configuration received from the NTN node 310-a. In some examples, the configuration may indicate a satellite type or an NTN cell type. For example, the UE 115 may transmit the indication if the satellite provides an Earth-moving cell, but the UE 115 may not transmit the indication if the satellite provides a quasi-Earth fixed cell.

In an example, the NTN node 310-a may transmit an indication 315-a of coverage information to the UE 115-b. In some examples, the NTN node 310-a may transmit control signaling indicating a configuration including the indication 315-a of coverage information. In some examples, the indication 315-a of the coverage information may indicate a satellite type or NTN cell type of the NTN node 310-a or a satellite of the NTN node 310-a. The indication 315-a of the coverage information may configure for the UE 115-b to report an indication when an estimated time duration for the UE 115-b to stay in the cell footprint 305-a is not long enough to perform a measurement-based, or conditional, handover.

Based on the indication 315-a of the coverage information, the UE 115-b may estimate the time duration to stay in coverage of serving cell provided by the satellite. The UE 115-b may determine that there is insufficient time for the UE 115-b to perform a measurement-based handover before the UE 115-b leaves the cell footprint 305-a, and the UE 115-b may transmit a message 320-a indicating timing information to the NTN node 310-a. For example, the message 320-a may indicate that the UE 115-b does not have sufficient time to perform a measurement-based handover before leaving the cell footprint.

Upon receiving the indication (e.g., the message 320-a) from the UE 115-b, the network may determine to support the UE 115-b without using a measurement-based handover. For example, the NTN node 310-a may not send a measurement configuration to the UE 115-b in the cell footprint 305-a, or the NTN node 310-a may configure the UE 115-b for a handover (e.g., a conditional handover) without a measurement report from the UE 115-b. For example, the NTN node 310-a may transmit control signaling 325 configuring the UE 115-b for a non-measurement-based handover or for a handover without an associated measurement report, e.g., a conditional handover. In some examples, the NTN node 310-a may configure the UE 115-b for a non-measurement-based handover, e.g., based on a location information of the UE 115-b. In some examples, geolocation information, such as Global Positioning System (GPS) information, may be an example of the location information of the UE 115-b, which may be reported by the UE 115-b or determined by the NTN node 310-a.

In some examples, a message 320 may include a UE recommendation to not use a measurement-based handover for the UE 115. For example, the message 320-a may recommend not to use a measurement-based handover for the UE 115-b. In some examples, the message 320 may indicate a UE's estimated time duration that the UE 115 will stay in the serving cell's coverage (e.g., the cell footprint 305-a). In some examples, the message 320 may indicate that the UE's estimated time duration is not long enough for a measurement-based handover. In some examples, the message 320 may indicate location information or positioning information of the UE 115.

In another example, the NTN node 310-a may transmit an indication 315-b of coverage information to the UE 115-c. The UE 115-c may estimate a time duration for the UE 115-c to remain in the serving cell's coverage, or the cell footprint 305-a, and determine if the estimated time duration is long enough for a measurement-based handover.

The UE 115-c may determine that there is sufficient time for the UE 115-c to perform a measurement-based handover before leaving the cell footprint 305-a. In some examples, the UE 115-c may not transmit a message 320-b indicating timing information. For example, the absence of the message 320-b indicating the timing information may imply that the UE 115-c has sufficient time to perform a measurement-based handover. After a window, occasion, resource, or time span associated with the UE 115-c transmitting the message 320-b has elapsed, the NTN node 310-a may determine that the UE 115-c did not transmit the message 320-b, and the UE 115-c can perform the measurement-based handover before leaving the cell footprint 305-a.

In some other examples, the UE 115-c may transmit a message 320-b indicating timing information, and the message 320-b may indicate that the UE 115-c does have sufficient time to perform a measurement-based handover. For example, the UE 115-c may transmit the message 320-b indicate a recommendation for the UE 115-c to use a measurement-based handover or an indication that the estimated time duration is sufficient for the UE 115-c to perform a measurement-based handover before leaving the cell footprint 305-a.

Based on either not receiving an indication or receiving an indication that the UE 115-c can perform the measurement-based handover, the NTN node 310-a may transmit control signaling 330 configuring the UE 115-c for a measurement-based handover. For example, the control signaling 330 may indicate or configure the UE 115-c with one or more measurement events for a measurement-based report/handover. In some examples, the UE 115-c may be configured for a measurement-based report or a measurement-based handover to another cell provided by the NTN node 310-a, a different NTN node 310 (e.g., the NTN node 310-b), or another network entity 105.

In some examples, the NTN node 310-a may indicate a timing threshold. A UE 115 may determine whether to transmit the message 320 based on the timing threshold and an estimated time duration until the UE 115 leaves the cell footprint 305-a. For example, if the estimated time duration for the UE 115 to stay in the serving cell's coverage is below the timing threshold, the UE 115 may determine to transmit the message 320, indicating that the UE 115 does not have enough time to perform the measurement-based handover. In some examples, the network may determine the timing threshold based on an estimated minimal time duration to perform a measurement-based handover procedure. In some examples, the UE 115 may estimate the time duration to stay in the serving cell's coverage (e.g., stay in the cell footprint 305-a) based on at least a location of the UE 115, information of the satellite (e.g., an ephemeris of the satellite), a reference location of the cell or cell footprint 305-a, a radius of the serving cell or cell footprint 305-a, or any combination thereof. In some examples, an ephemeris of the satellite may refer to a set of data or information associated with a position of the satellite at an associated epoch time and movement of the satellite, such as a trajectory or velocity of the satellite, among other information. In some examples, the UE 115 may implement a satellite movement propagator to predict or estimate a position of the satellite at a given time. In some examples, the timing threshold may be indicated with the indication 315 of the coverage information or separately.

In some examples, the UE 115 may determine whether to transmit the message 320 based on a first estimated duration for the UE 115 to remain in the cell footprint 305-a and a second estimated duration for the UE 115 to perform a measurement-based handover. For example, the UE 115 may estimate both the first duration and the second duration, and the UE 115 may determine whether to transmit the message 320 based on the estimates. In some examples, the UE 115 may estimate the second time duration associated with performing the measurement-based handover based on parameters associated with an implementation of the UE 115, such as a quantity of antennas, antenna panels, or antenna arrays in a VSAT UE (e.g., which may impact a time duration for the UE 115 to tune to different neighbor cells). Additionally, or alternatively, the UE 115 may determine the second time duration associated with performing the measurement-based handover based on one or more parameters, such as a UE-to-satellite round trip time, which may impact the signaling propagation delay.

In some examples, the NTN node 310-a may transmit, to the UE 115, one or more parameters associated with a network configuration for mobility, measurements, or handovers. For example, the one or more parameters may include a synchronization signal block (SSB) measurement timing configuration (SMTC) periodicity, a measurement gap repetition period (MGRP), or both. The SMTC periodicity and/or MGRP may affect the time duration for the UE 115 to detect that a measurement reporting event has been triggered. Thus, the UE 115 may consider the one or more parameters (e.g., associated with the network configuration and/or network implementation) and parameters of the UE 115 (e.g., a quantity of antennas at the UE 115) to estimate a time duration for the UE 115 to perform the measurement-based handover. For example, the UE 115 may estimate a time duration for the UE 115 to perform the measurement-based handover based on the SMTC periodicity, the MGRP, a quantity of antennas or antenna arrays at the UE 115, a type of antennas or antenna arrays at the UE 115, an RTT to the satellite, or any combination thereof.

The NTN node 310-a may indicate the timing threshold or any of the one or more parameters to the UE 115 via control signaling or system information signaling. For example, the timing threshold or any of the one or more parameters may be indicated via a SIB, an RRC message, a MAC control element or MAC message, or any combination thereof. In some examples, the timing threshold or any of the one or more or more parameters, or both, may be indicated with or via the indication 315 of the coverage information.

In some examples, the NTN node 310-a may indicate one or more parameters via existing signal to the UE 115, and the UE 115 may use the one or more parameters indicated via existing signaling to estimate a time duration until the UE 115 leaves the cell footprint 305-a. For example, the NTN node 310-a may indicate the one or more parameters via existing information elements in an RRC message or a SIB message. In some examples, the UE 115 may determine whether to transmit the message 320 after the UE 115 receives a measurement configuration, which may include one or more parameters the UE 115 may use to estimate a time duration until the UE 115 needs to perform a measurement-based handover. For example, the measurement configuration may indicate an SMTC periodicity or an MGRP, and the UE 115 may estimate a time duration the UE 115 needs to perform a measurement-based handover based on the SMTC periodicity or the MGRP indicated via the measurement configuration. In some examples, the UE 115 may not perform a measurement configured by the measurement configuration if the UE 115 transmits the message 320 indicating that the UE 115 does not have sufficient time to perform the measurement.

In some examples, a UE 115 may indicate information to the NTN node 310-a, such as location information of the UE 115 or an estimated time duration for the UE 115 to remain in the cell footprint. The UE 115 may indicate the information via a message 320 or via a separate transmission. In some examples, the UE 115 may indicate the information based on a first configuration, such as a configuration including the indication 315 of the coverage information of the cell, or based on a second, separate configuration. In an example, the UE 115-b may transmit the message 320-a indicating that the UE 115-b does not have sufficient time to perform a measurement-based handover, and the NTN node 310-a may transmit the control signaling 325 configuring the UE 115-b for a non-measurement-based handover or for a handover without an associated measurement report, e.g., a conditional handover. The UE 115-b may transmit a second message in response to the control signaling 325, indicating the estimated time duration until the UE 115-b leaves the cell footprint or positioning information of the UE 115-b.

In some examples, a UE 115 may transmit a message 320 indicating timing information during or after a random access channel (RACH) procedure. For example, the UE 115 may transmit the message 320 to the NTN node 310-a in a Message 3 or Message 5 of a RACH procedure or in a next uplink message after the UE 115 performs the RACH procedure. In some examples, the UE 115 may transmit the message 320 using a configured RACH preamble and/or a configured RACH occasion. For example, the NTN node 310-a may transmit a SIB indicating a RACH preamble and/or a RACH occasion for the message 320 indicating the timing information, and the UE 115 may transmit the message 320 indicating the timing information using the RACH preamble or RACH occasion indicated by the SIB.

FIG. 4 illustrates an example of an Earth-moving cell scenario 400 and a quasi-Earth fixed cell scenario that support techniques for NTN mobility with a moving cell in accordance with one or more aspects of the present disclosure. The Earth-moving cell scenario 400 and the quasi-Earth fixed cell scenario may each implement aspects of a wireless communications system 100, a network architecture 200, or a wireless communications system 300 as described with reference to FIGS. 1 through 3. In some cases, the Earth-moving cell scenario 400 may be an example of a planet-moving cell scenario, and the quasi-Earth fixed cell scenario may be an example of a quasi-planet fixed cell scenario.

In some examples, a wireless communications system, such as an NTN, may implement aspects of the Earth-moving cell scenario 400. In the Earth-moving cell scenario 400, a satellite 410-a may project a cell footprint 405 onto the Earth, and the cell footprint 405 may move with the satellite 410-a. If the satellite 410-a moves from east to west, the cell footprint 405 projected onto the Earth may move with the satellite 410-a from east to west. For example, at a first time, the satellite 410-a may project cell footprint 405-a. As the satellite 410-a moves from left to right, the cell footprint 405 of the cell from the satellite 410-a may also move from left to right. For example, at a second time, the satellite 410-a may have moved, and the satellite 410-a may project cell footprint 405-b in a different location.

For the quasi-Earth fixed cell scenario 401, a satellite 410-b may project a cell footprint 405 which remains static for a certain duration of time. For example, at a first time, the satellite 410-b may project a cell footprint 405-c. Even as the satellite 410-b moves from left to right, the satellite 410-b may adjust the direction of the projected footprint, and the cell footprint 405-c may remain statically fixed to a same position on the Earth. For example, at a first time, the cell footprint 405-c from the satellite 410-b may be projected at an angle 415-a, and at a second time, the cell footprint 405-c may be projected from the satellite 410-b at an angle 415-b. In some examples, the satellite 410-b may change the location of the cell footprint 405-c after a period of time. For example, once the satellite 410-b moves a configured distance from the cell footprint 405-c or an angle of the cell footprint 405-c from the satellite 410-b satisfies a threshold, the satellite 410-b may adjust the location of the cell footprint.

Techniques described herein may support mobility for an NTN which implements an Earth-moving cell scenario 400. For example, a UE may indicate to an NTN node, which may include a satellite 410, whether the UE has sufficient time to perform a measurement-based handover before leaving the cell footprint 405-a, or before the cell footprint 405-a moves such that the UE is no longer in coverage of the cell. Additionally, some aspects may be implemented in a quasi-Earth fixed cell scenario 401.

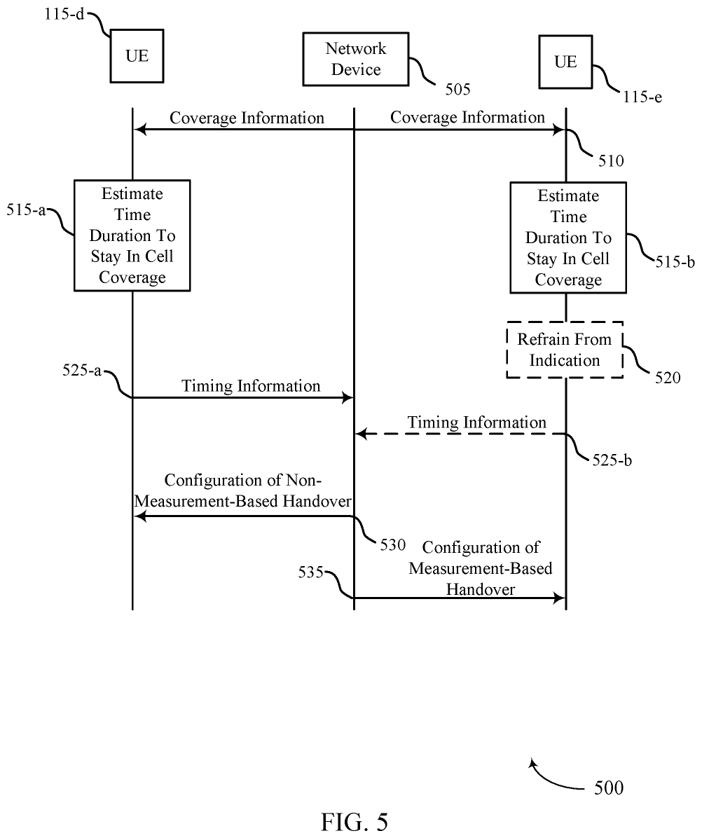

FIG. 5 illustrates an example of a process flow 500 that supports techniques for NTN mobility with a moving cell in accordance with one or more aspects of the present disclosure. In some examples, the process flow 500 may implement, or be implemented by, aspects of wireless communications systems 100, the network architecture 200, the wireless communications system 300, the Earth-moving cell scenario 400, the quasi-Earth fixed cell scenario 401, or any combination thereof.

In some cases, process flow 500 may include a UE 115-d, a UE 115-e, and a network device 505, which may be examples of corresponding devices as described herein. For example, the UE 115-d and the UE 115-e may each be an example of a UE 115 as described with reference to FIGS. 1 through 4. The network device 505 may be an example of, or include aspects of, an NTN node, a non-terrestrial device, a satellite, a network entity 105, such as a non-terrestrial network entity or a terrestrial network entity, or any combination thereof, as described with reference to FIGS. 1 through 4.

In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 510, the network device 505 may transmit, or output, an indication of coverage information for a first cell associated with an NTN. The coverage information may indicate a coverage area supported by the first cell for wireless communications. In some examples, the first cell may be provided by an NTN node, such as a satellite. In some examples, the network device 505 may transmit a configuration for a UE 115 (e.g., the UE 115-d or the UE 115-e, or both) to report an indication when the UE's estimated time duration to stay in the serving cell's coverage is not long enough to perform a measurement-based handover. In some examples, the network device 505 may transmit a configuration for a UE 115 (e.g., the UE 115-d or the UE 115-e, or both) indicating fields, parameters, or content to be included in the reported indication when the UE's estimated time duration to stay in the serving cell's coverage is not long enough to perform a measurement-based handover.

The UE 115-d may be an example of a UE 115 which does not have sufficient time to perform a measurement-based handover before leaving the coverage area supported by the first cell for wireless communications. At 515-a, the UE 115-d may estimate a time duration to stay in the serving cell's coverage, and the UE 115-d may determine whether the estimated time duration is long enough to complete a measurement-based handover.

At 525-a, the UE 115-d may transmit a message indicating a timing information associated with a measurement-based handover for the UE from the first cell to a second cell associated with the NTN. For example, the UE 115-d may transmit the message indicating that there is not sufficient time for the UE 115-d to perform a measurement-based handover before the UE 115-d leaves the coverage area of the first cell. In some examples, the message may indicate a recommendation for the UE 115-d to perform a non-measurement-based handover, that the UE 115-d cannot complete the measurement-based handover before leaving the coverage area of the first cell, an estimated time duration associated with the UE 115-d remaining in the coverage area of the first cell, a position of the UE 115-d, or any combination thereof.

In some examples, the UE 115-d may receive an indication of a timing threshold. The UE 115-d may transmit the message at 525 based on a time duration associated with the UE 115-d remaining within the coverage area supported by the first cell failing to satisfy the timing threshold. For example, the UE 115-d may estimate the time duration to stay in the cell coverage, and the UE 115-d may determine that the estimated time duration that the UE 115-d will stay in the cell coverage does not satisfy the indicated timing threshold.

In some examples, the UE 115-d may receive (e.g., from the network device 505) an indication of one or more parameters associated with the measurement-based handover for the UE. The UE 115-d may transmit the message at 525-a based on a first time duration associated with the UE 115-d being within the coverage area supported by the first cell being smaller than a second time duration associated with the UE 115-d performing the measurement-based handover.

In some examples, the first time duration may be based on the location information of the UE 115-d, an ephemeris of a satellite associated with the first cell, a reference location of the first cell, a radius of the first cell, the coverage information, or any combination thereof.

The second time duration may be based on any combination of the one or more parameters associated with the measurement-based handover or UE characteristics associated with the measurement-based handover, or both. For example, the one or more parameters associated with the measurement-based handover may include a measurement periodicity, a measurement gap repetition period, or both. The UE characteristics may include, for example, a quantity or a characteristic of antennas or antenna arrays of the UE 115-d, a round-trip-time between the UE 115-d and the first cell or the second cell, or both.

In some examples, the UE 115-d may receive an indication of parameters to perform a measurement for the measurement-based handover from the first cell to the second cell. In some examples, the one or more parameters associated with the measurement-based handover may be based on the parameters to perform the measurement for the measurement-based handover. For example, the UE 115-d may receive a measurement configuration indicating the measurement periodicity or the measurement gap repetition period, and the UE 115-d may estimate a time duration for performing the measurement-based handover based on the measurement periodicity or measurement gap repetition period indicated by the measurement configuration.

The network device 505 may obtain, or receive, the message indicating the timing information from the UE 115-d. At 530, the network device 505 may transmit a configuration of a non-measurement-based handover in response to the message indicating the timing information. For example, upon receiving the indication from the UE 115-d, the network device 505 may decide to support the UE 115-d without using a measurement-based handover. For example, the network device 505 may send a measurement configuration to the UE 115-d, or the network device 505 may configure the UE 115-d for a handover (e.g., a conditional handover) without a measurement report from the UE 115-d.

The UE 115-e may be an example of a UE 115 which does have sufficient time to perform a measurement-based handover before leaving the coverage area supported by the first cell for wireless communications. At 515-b, the UE 115-e may estimate a time duration to stay in the serving cell's coverage, and the UE 115-e may determine whether the estimated time duration is long enough to complete a measurement-based handover. In some examples, the UE 115-e may receive, similar to the UE 115-e, configurations or parameters to determine whether the UE 115-e has sufficient time to perform the measurement-based handover. For example, the UE 115-e may receive an indication of a timing threshold, parameters associated with a measurement-based handover, measurement timings or periodicities, and the like.

In some examples, the UE 115-e may, at 520, refrain from transmitting a message indicating timing information to the network device 505. For example, because the UE 115-e has sufficient time to perform the measurement handover, the UE 115-e may not transmit a message indicating that the UE 115-e cannot perform the measurement handover in time.

At 535, the UE 115-e may receive a handover command associated with a measurement-based handover for the UE 115-e. In some examples, the UE 115-e may receive the handover command after a timing associated with time resources allocated for transmission of an indication of a time estimation associated with a connection between the first cell and the UE 115-e. For example, after a timing or window associated with the UE 115-e transmitting a message indicating timing information elapses, the network device 505 may determine that the UE 115-e can perform a measurement-based handover before the UE 115-e leaves the coverage area of the cell. In some examples, after a RACH occasion configured for the UE 115-e to use to indicate the timing information elapses, or after the UE completes its connection setup procedure without an indication of the timing information, the network device 505 may determine that the UE 115-e did not indicate the timing information and therefore can complete the measurement-based handover in time. Based on determining that the UE 115-e can perform the measurement-based handover in time, the network device 505 may output, or transmit to the UE 115-e, a configuration for a measurement-based handover or a handover command associated with a measurement-based handover.

In some examples, the UE 115-e may transmit a message to the network device 505 at 525-b, the message indicating timing information associated with performing a measurement-based handover. For example, the UE 115-e may transmit a message indicating that the UE 115-e can perform the measurement-based handover before leaving the coverage area supported by the first cell. For example, the UE 115-e may determine that the UE 115-e can complete a measurement-based handover and be handed over to a second cell before the coverage area of the cell moves such that the UE 115-e is no longer in the coverage area of the cell.

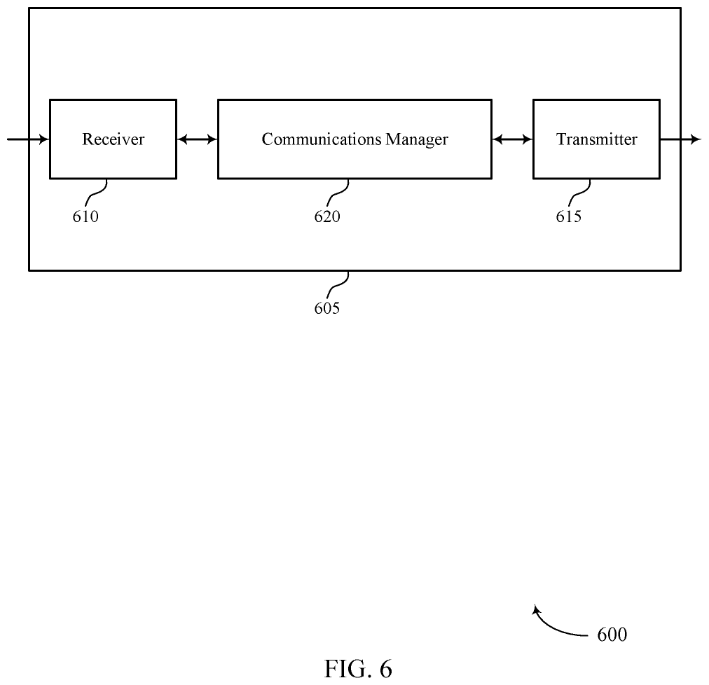

FIG. 6 illustrates a block diagram 600 of a device 605 that supports techniques for NTN mobility with a moving cell in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for NTN mobility with a moving cell). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for NTN mobility with a moving cell). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for NTN mobility with a moving cell as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving an indication of coverage information for a first cell associated with a NTN, the coverage information indicating a coverage area supported by the first cell for wireless communications. The communications manager 620 may be configured as or otherwise support a means for transmitting, based on location information of the UE and the coverage information, a message indicating a timing information associated with a measurement-based handover for the UE from the first cell to a second cell associated with the NTN.

Additionally, or alternatively, the communications manager 620 may support wireless communications at a UE in accordance with examples as disclosed herein. For example, the communications manager 620 may be configured as or otherwise support a means for receiving an indication of coverage information for a first cell associated with a NTN, the coverage information indicating a coverage area supported by the first cell for wireless communications. The communications manager 620 may be configured as or otherwise support a means for receiving, after a timing associated with time resources allocated for transmission of an indication of a time estimation associated with a connection between the first cell and the UE, a handover command associated with a measurement-based handover for the UE.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources. For example, by indicating whether a UE 115 is able to complete a measurement-based handover prior to leaving a coverage area of a cell in an NTN, a network device or a network node may determine whether to send signaling to configure the UE 115 with measurement events for the measurement-based handover. If the UE 115 cannot complete the measurement-based handover in time, the network device or network node may not configure the UE 115 with the measurement events, reducing overhead and improving resource availability.

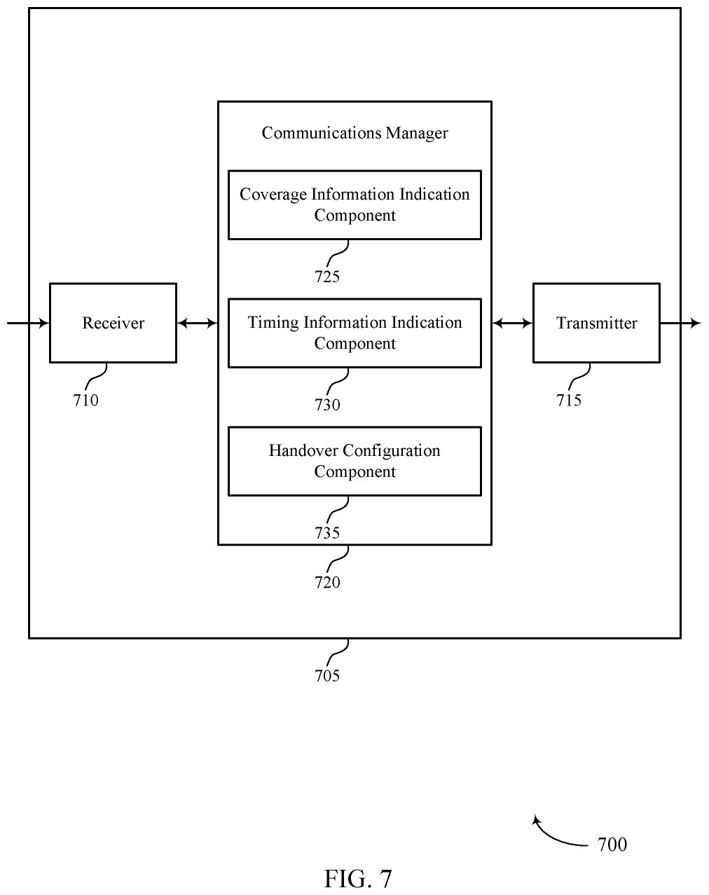

FIG. 7 illustrates a block diagram 700 of a device 705 that supports techniques for NTN mobility with a moving cell in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for NTN mobility with a moving cell). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for NTN mobility with a moving cell). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for NTN mobility with a moving cell as described herein. For example, the communications manager 720 may include a coverage information indication component 725, a timing information indication component 730, a handover configuration component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The coverage information indication component 725 may be configured as or otherwise support a means for receiving an indication of coverage information for a first cell associated with a NTN, the coverage information indicating a coverage area supported by the first cell for wireless communications. The timing information indication component 730 may be configured as or otherwise support a means for transmitting, based on location information of the UE and the coverage information, a message indicating a timing information associated with a measurement-based handover for the UE from the first cell to a second cell associated with the NTN.

Additionally, or alternatively, the communications manager 720 may support wireless communications at a UE in accordance with examples as disclosed herein. The coverage information indication component 725 may be configured as or otherwise support a means for receiving an indication of coverage information for a first cell associated with a NTN, the coverage information indicating a coverage area supported by the first cell for wireless communications. The handover configuration component 735 may be configured as or otherwise support a means for receiving, after a timing associated with time resources allocated for transmission of an indication of a time estimation associated with a connection between the first cell and the UE, a handover command associated with a measurement-based handover for the UE.

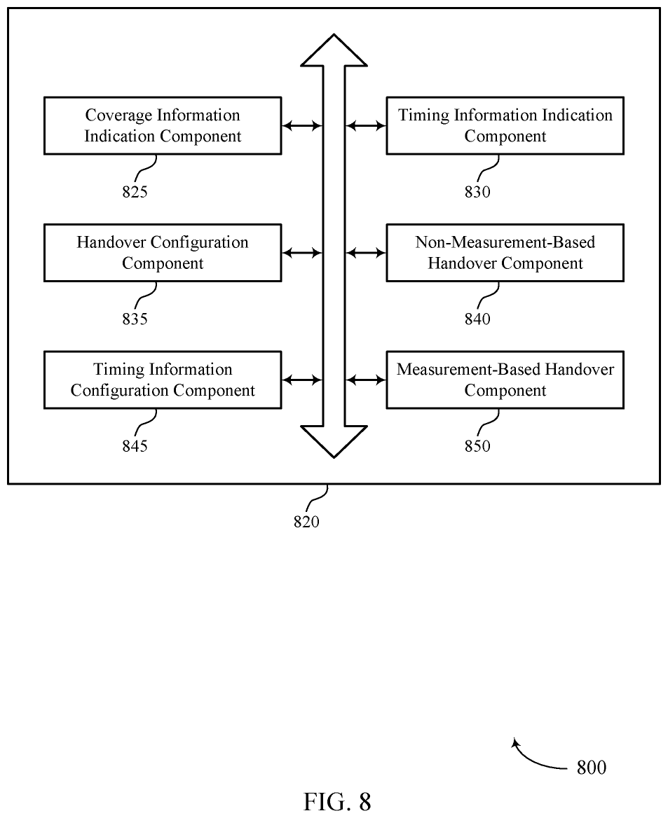

FIG. 8 illustrates a block diagram 800 of a communications manager 820 that supports techniques for NTN mobility with a moving cell in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for NTN mobility with a moving cell as described herein. For example, the communications manager 820 may include a coverage information indication component 825, a timing information indication component 830, a handover configuration component 835, a non-measurement-based handover component 840, a timing information configuration component 845, a measurement-based handover component 850, or any combination thereof. Each of these components may communicate, directly or indirectly, with one another (e.g., via one or more buses).

The communications manager 820 may support wireless communications at a UE in accordance with examples as disclosed herein. The coverage information indication component 825 may be configured as or otherwise support a means for receiving an indication of coverage information for a first cell associated with a NTN, the coverage information indicating a coverage area supported by the first cell for wireless communications. The timing information indication component 830 may be configured as or otherwise support a means for transmitting, based on location information of the UE and the coverage information, a message indicating a timing information associated with a measurement-based handover for the UE from the first cell to a second cell associated with the NTN.

In some examples, the non-measurement-based handover component 840 may be configured as or otherwise support a means for receiving, in response to the message indicating the timing information, control signaling associated with a non-measurement-based handover for the UE from the first cell to the second cell.

In some examples, the non-measurement-based handover component 840 may be configured as or otherwise support a means for performing the non-measurement-based handover from the first cell to the second cell based on the control signaling.

In some examples, the timing information configuration component 845 may be configured as or otherwise support a means for receiving, from the NTN, a configuration to transmit the message indicating the timing information, the message indicating the timing information being transmitted in response to the configuration received from the NTN.

In some examples, the configuration is associated with one of a satellite type or a non-terrestrial cell type of the first cell or the second cell, or both.

In some examples, the timing information configuration component 845 may be configured as or otherwise support a means for receiving an indication of a timing threshold, the message being transmitted based on a time duration associated with the UE remaining within the coverage area supported by the first cell failing to satisfy the timing threshold.

In some examples, the time duration associated with the UE remaining within the coverage area supported by the first cell is based on the location information of the UE, an ephemeris of a satellite associated with the first cell, a reference location of the first cell, a radius of the first cell, the coverage information, or any combination thereof.

In some examples, the message is transmitted based on a first time duration associated with the UE being within the coverage area supported by the first cell being smaller than a second time duration, the second time duration associated with UE characteristics for the measurement-based handover.

In some examples, the second time duration associated with the UE characteristics is based on a quantity or a characteristic of antennas of the UE, a round-trip-time between the UE and the first cell or the second cell, or any combination thereof.

In some examples, the timing information configuration component 845 may be configured as or otherwise support a means for receiving an indication of one or more parameters associated with the measurement-based handover for the UE, the message being transmitted based on a first time duration associated with the UE being within the coverage area supported by the first cell being smaller than a second time duration associated with the UE performing the measurement-based handover, the second time duration being based on any combination of the one or more parameters associated with the measurement-based handover or UE characteristics associated with the measurement-based handover, or both.

In some examples, the one or more parameters associated with the measurement-based handover include a measurement periodicity, a measurement gap repetition period, or both.

In some examples, the indication of the one or more parameters is received via a SIB, an RRC message, a MAC message, or any combination thereof.

In some examples, the handover configuration component 835 may be configured as or otherwise support a means for receiving an indication of parameters to perform a measurement for the measurement-based handover from the first cell to the second cell, the one or more parameters associated with the measurement-based handover being based on the parameters to perform the measurement for the measurement-based handover.

In some examples, to support transmitting the message, the timing information indication component 830 may be configured as or otherwise support a means for transmitting the message indicating a recommendation for the UE to perform the measurement-based handover or a non-measurement-based handover, that the UE cannot complete the measurement-based handover before leaving the coverage area of the first cell, an estimated time duration associated with the UE remaining in the coverage area of the first cell, a position of the UE, or any combination thereof.

In some examples, the timing information configuration component 845 may be configured as or otherwise support a means for receiving, from the NTN, a configuration indicating one or more parameters for the timing information or a granularity of the timing information, the timing information based on the configuration received from the NTN.

In some examples, the message is transmitted via a third message or a fifth message of a random access procedure, an uplink message after the random access procedure, a random access preamble, a random access occasion, or any combination thereof.

Additionally, or alternatively, the communications manager 820 may support wireless communications at a UE in accordance with examples as disclosed herein. In some examples, the coverage information indication component 825 may be configured as or otherwise support a means for receiving an indication of coverage information for a first cell associated with a NTN, the coverage information indicating a coverage area supported by the first cell for wireless communications. The handover configuration component 835 may be configured as or otherwise support a means for receiving, after a timing associated with time resources allocated for transmission of an indication of a time estimation associated with a connection between the first cell and the UE, a handover command associated with a measurement-based handover for the UE.

In some examples, the timing information indication component 830 may be configured as or otherwise support a means for transmitting, based on location information of the UE and the coverage information, a message indicating timing information associated with the measurement-based handover from the first cell to a second cell associated with the NTN.

In some examples, the message indicates that the UE can perform the measurement-based handover before leaving the coverage area supported by the first cell.

In some examples, the measurement-based handover component 850 may be configured as or otherwise support a means for performing the measurement-based handover from the first cell to a second cell based on the handover command.

In some examples, the timing information configuration component 845 may be configured as or otherwise support a means for receiving an indication of a timing threshold, the handover command being received based on a time duration associated with the UE remaining within the coverage area supported by the first cell satisfying the timing threshold.

In some examples, the time duration associated with the UE remaining within the coverage area supported by the first cell is based on location information of the UE, an ephemeris of a satellite associated with of the first cell, a reference location of the first cell, a radius of the first cell, the coverage information, or any combination thereof.

In some examples, the handover command is received based on a first time duration associated with the UE being within the coverage area supported by the first cell being larger than a second time duration associated with UE characteristics for the measurement-based handover.

In some examples, the second time duration associated with the UE characteristics is based on a quantity or a characteristic of antennas of the UE, a round-trip-time between the UE and the first cell or a second cell associated with the handover command, or any combination thereof.

In some examples, the timing information configuration component 845 may be configured as or otherwise support a means for receiving an indication of one or more parameters associated with the measurement-based handover, the handover command being received based on a first time duration associated with the UE being within the coverage area supported by the first cell being larger than a second time duration associated with the UE performing the measurement-based handover, the second time duration based on any combination of the one or more parameters associated with the measurement-based handover or UE characteristics associated with the measurement-based handover, or both.

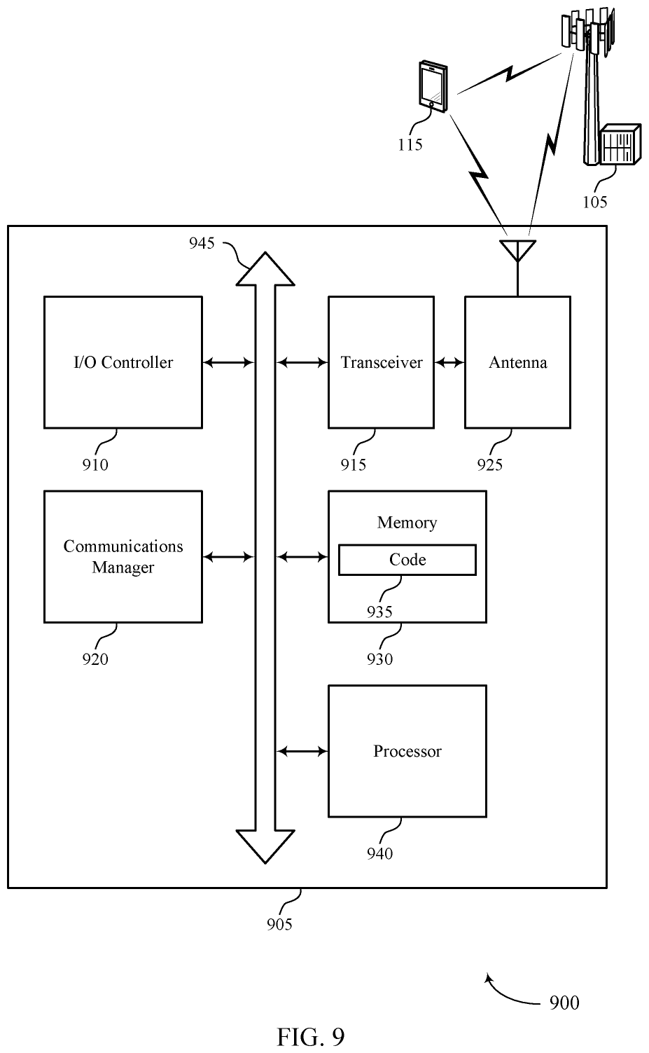

FIG. 9 illustrates a diagram of a system 900 including a device 905 that supports techniques for NTN mobility with a moving cell in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for NTN mobility with a moving cell). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving an indication of coverage information for a first cell associated with a NTN, the coverage information indicating a coverage area supported by the first cell for wireless communications. The communications manager 920 may be configured as or otherwise support a means for transmitting, based on location information of the UE and the coverage information, a message indicating a timing information associated with a measurement-based handover for the UE from the first cell to a second cell associated with the NTN.

Additionally, or alternatively, the communications manager 920 may support wireless communications at a UE in accordance with examples as disclosed herein. For example, the communications manager 920 may be configured as or otherwise support a means for receiving an indication of coverage information for a first cell associated with a NTN, the coverage information indicating a coverage area supported by the first cell for wireless communications. The communications manager 920 may be configured as or otherwise support a means for receiving, after a timing associated with time resources allocated for transmission of an indication of a time estimation associated with a connection between the first cell and the UE, a handover command associated with a measurement-based handover for the UE.

By including or configuring the communications manager 920 in accordance with examples as described herein, the device 905 may support techniques for more efficient utilization of communication resources. For example, by indicating whether a UE 115 is able to complete a measurement-based handover prior to leaving a coverage area of a cell in an NTN, a network device or a network node may determine whether to send signaling to configure the UE 115 with measurement events for the measurement-based handover. If the UE 115 cannot complete the measurement-based handover in time, the network device or network node may not configure the UE 115 with the measurement events, reducing overhead and improving resource availability. Additionally, these techniques may improve communication reliability and reduce service interruption time by utilizing an efficient mobility scheme (e.g., a measurement-based handover or a non-measurement-based handover) based on whether the UE 115 can perform the measurement-based handover in time.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for NTN mobility with a moving cell as described herein, or the processor 940 and the memory 930 may be otherwise configured to perform or support such operations.

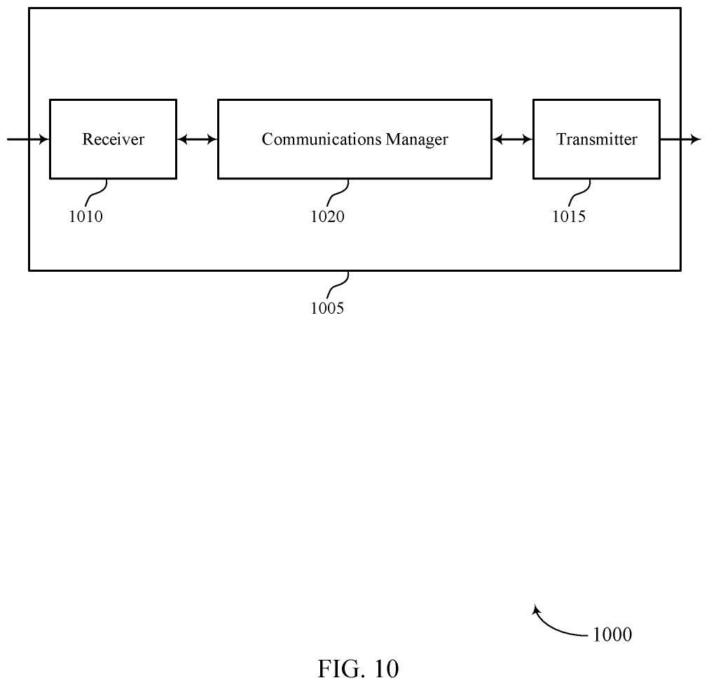

FIG. 10 illustrates a block diagram 1000 of a device 1005 that supports techniques for NTN mobility with a moving cell in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for NTN mobility with a moving cell as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network device in accordance with examples as disclosed herein. For example, the communications manager 1020 may be configured as or otherwise support a means for outputting an indication of coverage information for a first cell associated with a NTN, the coverage information indicating a coverage area supported by the first cell for wireless communications. The communications manager 1020 may be configured as or otherwise support a means for monitoring for a message indicating a timing information associated with a measurement-based handover from the first cell to a second cell associated with the NTN.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources. For example, by indicating whether a UE 115 is able to complete a measurement-based handover prior to leaving a coverage area of a cell in an NTN, a network device or a network node may determine whether to send signaling to configure the UE 115 with measurement events for the measurement-based handover. If the UE 115 cannot complete the measurement-based handover in time, the network device or network node may not configure the UE 115 with the measurement events, reducing overhead and improving resource availability. Additionally, these techniques may improve communication reliability and reduce service interruption time by utilizing an efficient mobility scheme (e.g., a measurement-based handover or a non-measurement-based handover) based on whether the UE 115 can perform the measurement-based handover in time.

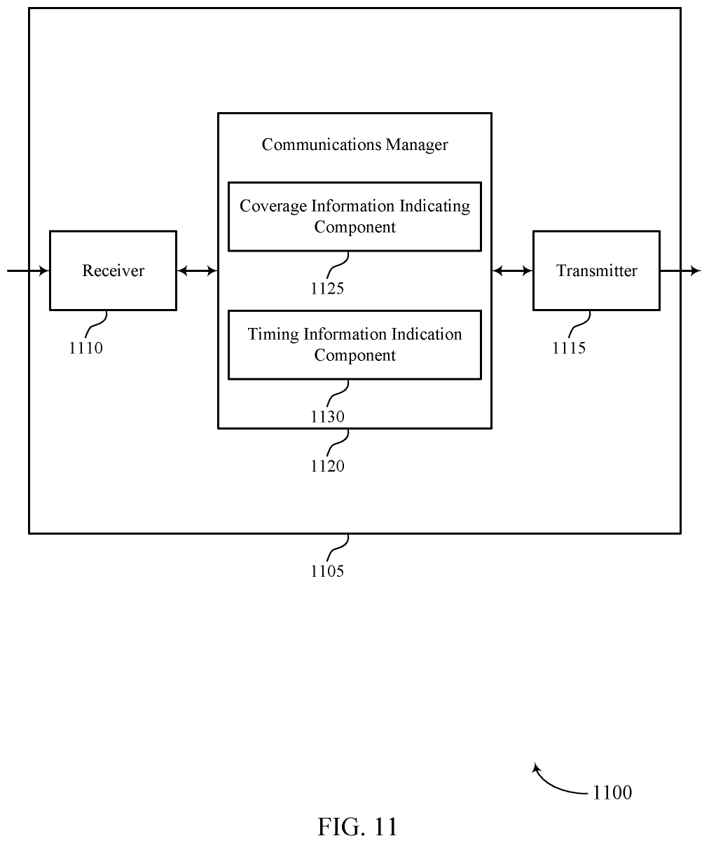

FIG. 11 illustrates a block diagram 1100 of a device 1105 that supports techniques for NTN mobility with a moving cell in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for NTN mobility with a moving cell as described herein. For example, the communications manager 1120 may include a coverage information indicating component 1125 a timing information indication component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network device in accordance with examples as disclosed herein. The coverage information indicating component 1125 may be configured as or otherwise support a means for outputting an indication of coverage information for a first cell associated with a NTN, the coverage information indicating a coverage area supported by the first cell for wireless communications. The timing information indication component 1130 may be configured as or otherwise support a means for monitoring for a message indicating a timing information associated with a measurement-based handover from the first cell to a second cell associated with the NTN.

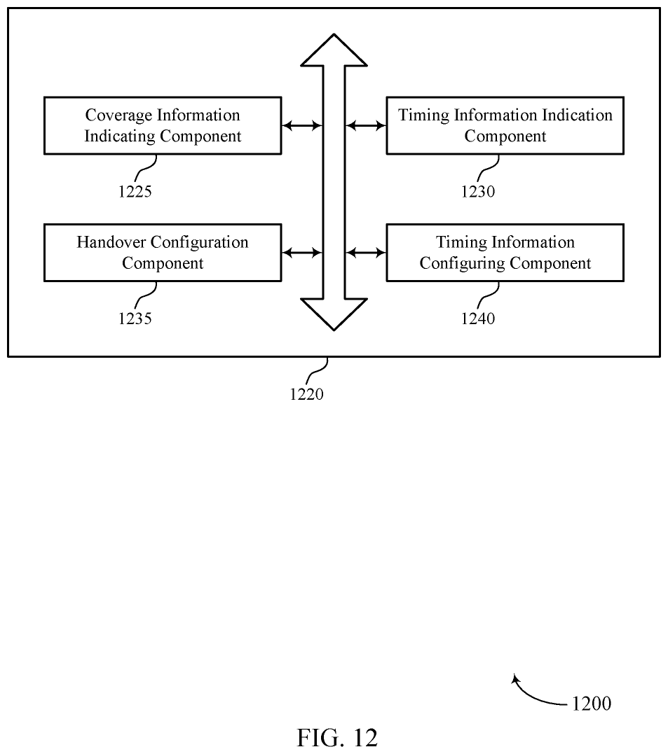

FIG. 12 illustrates a block diagram 1200 of a communications manager 1220 that supports techniques for NTN mobility with a moving cell in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for NTN mobility with a moving cell as described herein. For example, the communications manager 1220 may include a coverage information indicating component 1225, a timing information indication component 1230, a handover configuration component 1235, a timing information configuring component 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network device in accordance with examples as disclosed herein. The coverage information indicating component 1225 may be configured as or otherwise support a means for outputting an indication of coverage information for a first cell associated with a NTN, the coverage information indicating a coverage area supported by the first cell for wireless communications. The timing information indication component 1230 may be configured as or otherwise support a means for monitoring for a message indicating a timing information associated with a measurement-based handover from the first cell to a second cell associated with the NTN.

In some examples, to support monitoring for the message, the timing information indication component 1230 may be configured as or otherwise support a means for obtaining the message indicating the timing information associated with the measurement-based handover from the first cell to the second cell associated with the NTN.

In some examples, the handover configuration component 1235 may be configured as or otherwise support a means for outputting, in response to the message indicating the timing information, control signaling associated with a non-measurement-based handover from the first cell to the second cell.

In some examples, the timing information configuring component 1240 may be configured as or otherwise support a means for outputting a configuration for transmitting the message indicating the timing information, the message indicating the timing information being received based on the configuration.

In some examples, the configuration is associated with one of a satellite type or a non-terrestrial cell type of the first cell or the second cell, or both.

In some examples, the timing information configuring component 1240 may be configured as or otherwise support a means for outputting an indication of a timing threshold, the message indicating that a time duration associated with remaining within the coverage area supported by the first cell fails to satisfy the timing threshold.

In some examples, the message indicates that a first time duration associated with being within the coverage area supported by the first cell is smaller than a second time duration, the second time duration associated with wireless device characteristics for the measurement-based handover.

In some examples, the timing information configuring component 1240 may be configured as or otherwise support a means for outputting an indication of one or more parameters associated with the measurement-based handover, the message indicating that a first time duration associated with being within the coverage area supported by the first cell is smaller than a second time duration associated with a wireless device performing the measurement-based handover, the second time duration being based on any of the one or more parameters associated with the measurement-based handover, wireless device characteristics associated with the measurement-based handover, or both.

In some examples, the one or more parameters associated with the measurement-based handover include a measurement periodicity, a measurement gap repetition period, or both.

In some examples, the message indicates a recommendation for the measurement-based handover or a non-measurement-based handover, that a wireless device cannot complete the measurement-based handover prior leaving the coverage area of the first cell, an estimated time duration associated with the wireless device remaining in the coverage area of the first cell, a position of the wireless device, or any combination thereof.

In some examples, the timing information configuring component 1240 may be configured as or otherwise support a means for outputting a configuration indicating one or more parameters for the timing information or a granularity of the timing information, the timing information being based on the configuration.

In some examples, the message is obtained via a third message or a fifth message of a random access procedure, an uplink message after the random access procedure, a random access preamble, a random access occasion, or any combination thereof.

In some examples, the message indicates that a wireless device can perform the measurement-based handover before leaving the coverage area supported by the first cell.

In some examples, the message indicates that a wireless device cannot perform the measurement-based handover before leaving the coverage area supported by the first cell.

In some examples, the handover configuration component 1235 may be configured as or otherwise support a means for outputting, after a timing associated with time resources allocated for transmission of an indication of a time estimation associated with a connection between the first cell and a wireless device, a handover command associated with the measurement-based handover for the wireless device.

In some examples, the indication of the coverage information is transmitted via a SIB, an RRC message, a MAC message, or any combination thereof.

In some examples, the handover configuration component 1235 may be configured as or otherwise support a means for outputting an indication of one or more parameters to perform a measurement for the measurement-based handover from the first cell to the second cell, the message received in response to the indication of the one or more parameters.

In some examples, the timing information indication component 1230 may be configured as or otherwise support a means for obtaining a second message indicating a recommendation to perform the measurement-based handover or a non-measurement-based handover, an indication of whether the measurement-based handover can be completed prior to a wireless device leaving the coverage area of the first cell, an estimated time duration associated with the wireless device remaining in the coverage area of the first cell, a position of the wireless device, or any combination thereof.

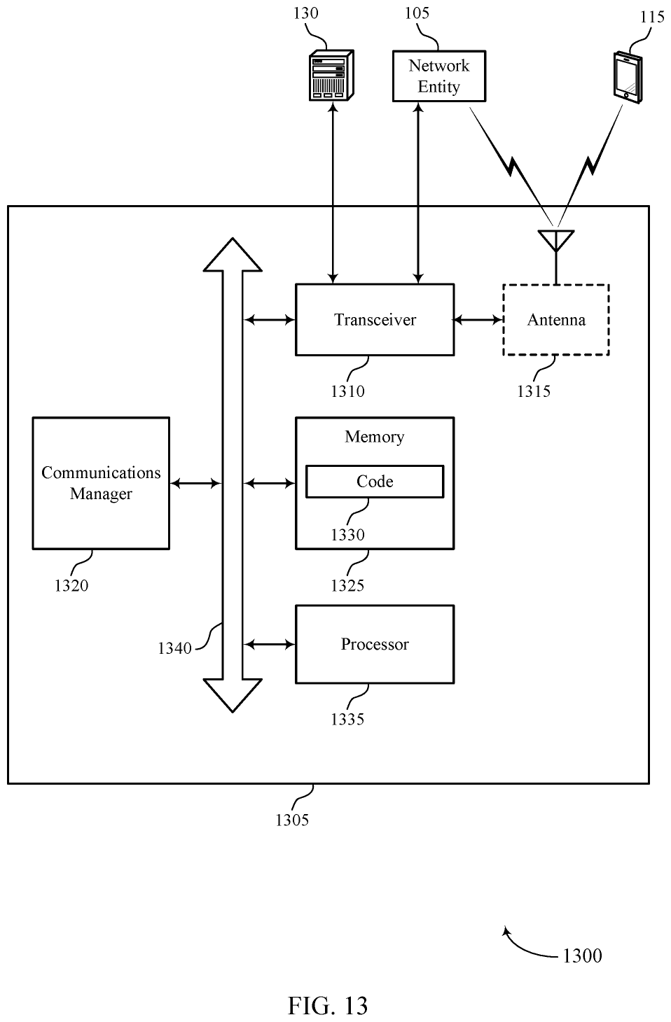

FIG. 13 illustrates a diagram of a system 1300 including a device 1305 that supports techniques for NTN mobility with a moving cell in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for NTN mobility with a moving cell). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network device in accordance with examples as disclosed herein. For example, the communications manager 1320 may be configured as or otherwise support a means for outputting an indication of coverage information for a first cell associated with a NTN, the coverage information indicating a coverage area supported by the first cell for wireless communications. The communications manager 1320 may be configured as or otherwise support a means for monitoring for a message indicating a timing information associated with a measurement-based handover from the first cell to a second cell associated with the NTN.

By including or configuring the communications manager 1320 in accordance with examples as described herein, the device 1305 may support techniques for more efficient utilization of communication resources. For example, by indicating whether a UE 115 is able to complete a measurement-based handover prior to leaving a coverage area of a cell in an NTN, a network device or a network node may determine whether to send signaling to configure the UE 115 with measurement events for the measurement-based handover. If the UE 115 cannot complete the measurement-based handover in time, the network device or network node may not configure the UE 115 with the measurement events, reducing overhead and improving resource availability. Additionally, these techniques may improve communication reliability and reduce service interruption time by utilizing an efficient mobility scheme (e.g., a measurement-based handover or a non-measurement-based handover) based on whether the UE 115 can perform the measurement-based handover in time.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for NTN mobility with a moving cell as described herein, or the processor 1335 and the memory 1325 may be otherwise configured to perform or support such operations.

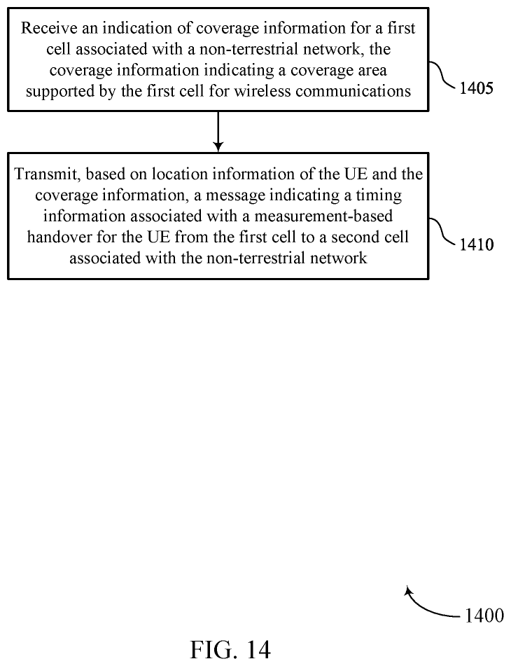

FIG. 14 illustrates a flowchart showing a method 1400 that supports techniques for NTN mobility with a moving cell in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving an indication of coverage information for a first cell associated with a NTN, the coverage information indicating a coverage area supported by the first cell for wireless communications. The operations of 1405 may be performed in accordance with examples as disclosed herein. In some examples, aspects of the operations of 1405 may be performed by a coverage information indication component 825 as described with reference to FIG. 8.

At 1410, the method may include transmitting, based on location information of the UE and the coverage information, a message indicating a timing information associated with a measurement-based handover for the UE from the first cell to a second cell associated with the NTN. The operations of 1410 may be performed in accordance with examples as disclosed herein. In some examples, aspects of the operations of 1410 may be performed by a timing information indication component 830 as described with reference to FIG. 8.

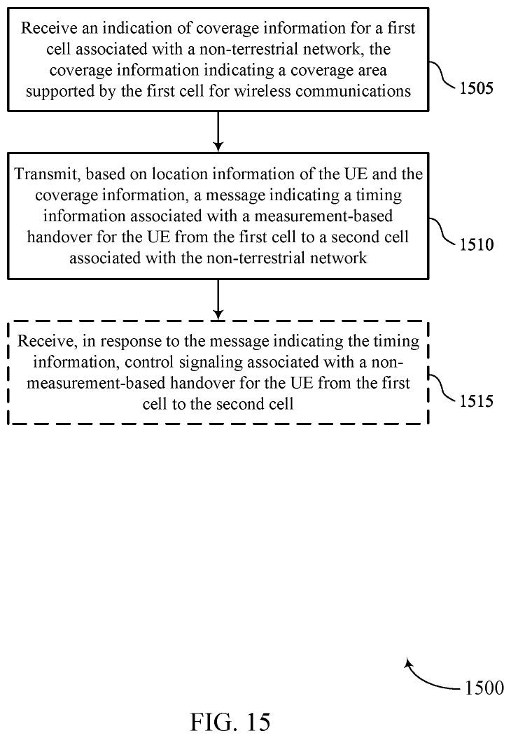

FIG. 15 illustrates a flowchart showing a method 1500 that supports techniques for NTN mobility with a moving cell in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving an indication of coverage information for a first cell associated with a NTN, the coverage information indicating a coverage area supported by the first cell for wireless communications. The operations of 1505 may be performed in accordance with examples as disclosed herein. In some examples, aspects of the operations of 1505 may be performed by a coverage information indication component 825 as described with reference to FIG. 8.

At 1510, the method may include transmitting, based on location information of the UE and the coverage information, a message indicating a timing information associated with a measurement-based handover for the UE from the first cell to a second cell associated with the NTN. The operations of 1510 may be performed in accordance with examples as disclosed herein. In some examples, aspects of the operations of 1510 may be performed by a timing information indication component 830 as described with reference to FIG. 8.

At 1515, the method may include receiving, in response to the message indicating the timing information, control signaling associated with a non-measurement-based handover for the UE from the first cell to the second cell. The operations of 1515 may be performed in accordance with examples as disclosed herein. In some examples, aspects of the operations of 1515 may be performed by a non-measurement-based handover component 840 as described with reference to FIG. 8.

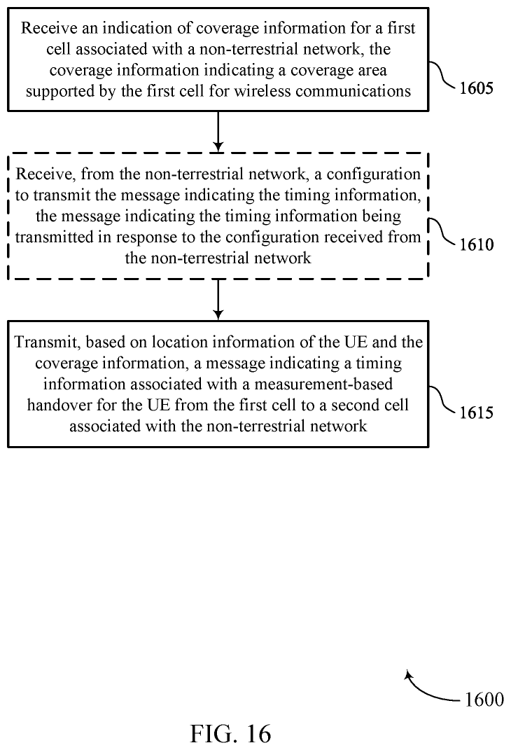

FIG. 16 illustrates a flowchart showing a method 1600 that supports techniques for NTN mobility with a moving cell in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving an indication of coverage information for a first cell associated with a NTN, the coverage information indicating a coverage area supported by the first cell for wireless communications. The operations of 1605 may be performed in accordance with examples as disclosed herein. In some examples, aspects of the operations of 1605 may be performed by a coverage information indication component 825 as described with reference to FIG. 8.

At 1610, the method may include receiving, from the NTN, a configuration to transmit the message indicating the timing information, the message indicating the timing information being transmitted in response to the configuration received from the NTN. The operations of 1610 may be performed in accordance with examples as disclosed herein. In some examples, aspects of the operations of 1610 may be performed by a timing information configuration component 845 as described with reference to FIG. 8.

At 1615, the method may include transmitting, based on location information of the UE and the coverage information, a message indicating a timing information associated with a measurement-based handover for the UE from the first cell to a second cell associated with the NTN. The operations of 1615 may be performed in accordance with examples as disclosed herein. In some examples, aspects of the operations of 1615 may be performed by a timing information indication component 830 as described with reference to FIG. 8.

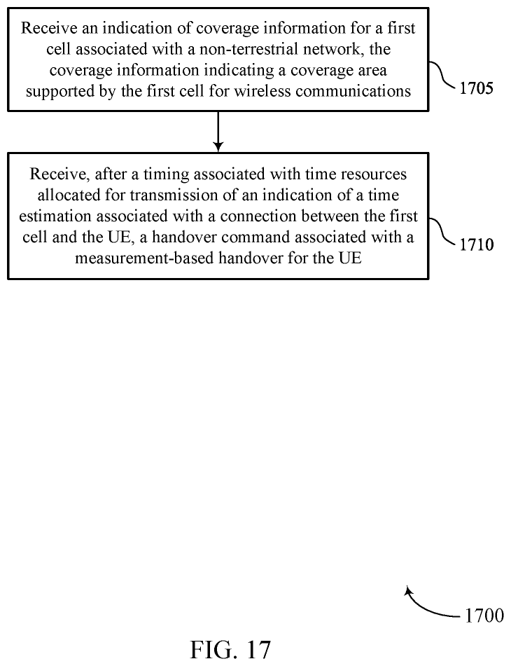

FIG. 17 illustrates a flowchart showing a method 1700 that supports techniques for NTN mobility with a moving cell in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving an indication of coverage information for a first cell associated with a NTN, the coverage information indicating a coverage area supported by the first cell for wireless communications. The operations of 1705 may be performed in accordance with examples as disclosed herein. In some examples, aspects of the operations of 1705 may be performed by a coverage information indication component 825 as described with reference to FIG. 8.

At 1710, the method may include receiving, after a timing associated with time resources allocated for transmission of an indication of a time estimation associated with a connection between the first cell and the UE, a handover command associated with a measurement-based handover for the UE. The operations of 1710 may be performed in accordance with examples as disclosed herein. In some examples, aspects of the operations of 1710 may be performed by a handover configuration component 835 as described with reference to FIG. 8.

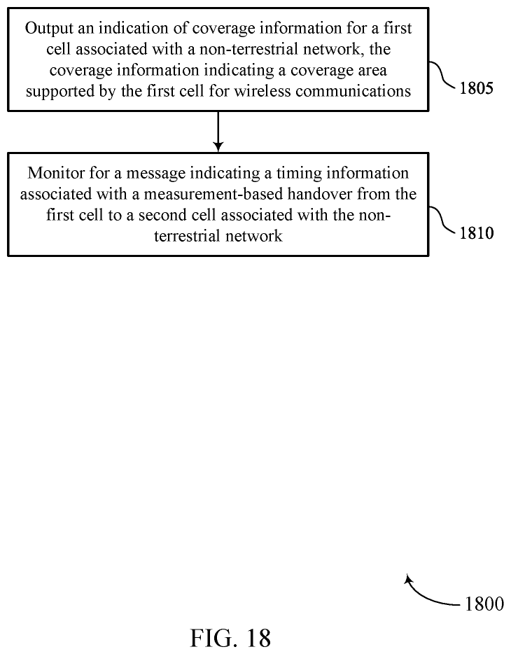

FIG. 18 illustrates a flowchart showing a method 1800 that supports techniques for NTN mobility with a moving cell in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include outputting an indication of coverage information for a first cell associated with a NTN, the coverage information indicating a coverage area supported by the first cell for wireless communications. The operations of 1805 may be performed in accordance with examples as disclosed herein. In some examples, aspects of the operations of 1805 may be performed by a coverage information indicating component 1225 as described with reference to FIG. 12.

At 1810, the method may include monitoring for a message indicating a timing information associated with a measurement-based handover from the first cell to a second cell associated with the NTN. The operations of 1810 may be performed in accordance with examples as disclosed herein. In some examples, aspects of the operations of 1810 may be performed by a timing information indication component 1230 as described with reference to FIG. 12.

The following provides an overview of aspects of the present disclosure:
Aspect 1: A method for wireless communications at a UE, comprising: receiving an indication of coverage information for a first cell associated with a non-terrestrial network, the coverage information indicating a coverage area supported by the first cell for wireless communications; and transmitting, based at least in part on location information of the UE and the coverage information, a message indicating a timing information associated with a measurement-based handover for the UE from the first cell to a second cell associated with the non-terrestrial network.
Aspect 2: The method of aspect 1, further comprising: receiving, in response to the message indicating the timing information, control signaling associated with a non-measurement-based handover for the UE from the first cell to the second cell.
Aspect 3: The method of aspect 2, further comprising: performing the non-measurement-based handover from the first cell to the second cell based at least in part on the control signaling.
Aspect 4: The method of any of aspects 1 through 3, further comprising: receiving, from the non-terrestrial network, a configuration to transmit the message indicating the timing information, the message indicating the timing information being transmitted in response to the configuration received from the non-terrestrial network.
Aspect 5: The method of aspect 4, wherein the configuration is associated with one of a satellite type or a non-terrestrial cell type of the first cell or the second cell, or both.
Aspect 6: The method of any of aspects 1 through 5, further comprising: receiving an indication of a timing threshold, the message being transmitted based at least in part on a time duration associated with the UE remaining within the coverage area supported by the first cell failing to satisfy the timing threshold.
Aspect 7: The method of aspect 6, wherein the time duration associated with the UE remaining within the coverage area supported by the first cell is based at least in part on the location information of the UE, an ephemeris of a satellite associated with the first cell, a reference location of the first cell, a radius of the first cell, the coverage information, or any combination thereof.
Aspect 8: The method of any of aspects 1 through 7, wherein the message is transmitted based at least in part on a first time duration associated with the UE being within the coverage area supported by the first cell being smaller than a second time duration, the second time duration associated with UE characteristics for the measurement-based handover.
Aspect 9: The method of aspect 8, wherein the second time duration associated with the UE characteristics is based at least in part on a quantity or a characteristic of antennas of the UE, a round-trip-time between the UE and the first cell or the second cell, or any combination thereof.
Aspect 10: The method of any of aspects 1 through 9, further comprising: receiving an indication of one or more parameters associated with the measurement-based handover for the UE, the message being transmitted based at least in part on a first time duration associated with the UE being within the coverage area supported by the first cell being smaller than a second time duration associated with the UE performing the measurement-based handover, the second time duration being based at least in part on any combination of the one or more parameters associated with the measurement-based handover or UE characteristics associated with the measurement-based handover, or both.
Aspect 11: The method of aspect 10, wherein the one or more parameters associated with the measurement-based handover include a measurement periodicity, a measurement gap repetition period, or both.
Aspect 12: The method of any of aspects 10 through 11, wherein the indication of the one or more parameters is received via a system information block, a Radio Resource Control message, a medium access control message, or any combination thereof.
Aspect 13: The method of any of aspects 10 through 12, further comprising: receiving an indication of parameters to perform a measurement for the measurement-based handover from the first cell to the second cell, the one or more parameters associated with the measurement-based handover being based at least in part on the parameters to perform the measurement for the measurement-based handover.
Aspect 14: The method of any of aspects 1 through 13, wherein transmitting the message comprises: transmitting the message indicating a recommendation for the UE to perform one of the measurement-based handover or a non-measurement-based handover, whether the UE can complete the measurement-based handover before leaving the coverage area of the first cell, an estimated time duration associated with the UE remaining in the coverage area of the first cell, a position of the UE, or any combination thereof.
Aspect 15: The method of aspect 14, further comprising: receiving, from the non-terrestrial network, a configuration indicating one or more parameters for the timing information or a granularity of the timing information, the timing information based at least in part on the configuration received from the non-terrestrial network.
Aspect 16: The method of any of aspects 1 through 15, wherein the message is transmitted via a third message or a fifth message of a random access procedure, an uplink message after the random access procedure, a random access preamble, a random access occasion, or any combination thereof.
Aspect 17: A method for wireless communications at a UE, comprising: receiving an indication of coverage information for a first cell associated with a non-terrestrial network, the coverage information indicating a coverage area supported by the first cell for wireless communications; and receiving, after a timing associated with time resources allocated for transmission of an indication of a time estimation associated with a connection between the first cell and the UE, a handover command associated with a measurement-based handover for the UE.
Aspect 18: The method of aspect 17, further comprising: transmitting, based at least in part on location information of the UE and the coverage information, a message indicating timing information associated with the measurement-based handover from the first cell to a second cell associated with the non-terrestrial network.
Aspect 19: The method of aspect 18, wherein the message indicates that the UE can perform the measurement-based handover before leaving the coverage area supported by the first cell.
Aspect 20: The method of any of aspects 17 through 19, further comprising: performing the measurement-based handover from the first cell to a second cell based at least in part on the handover command.
Aspect 21: The method of any of aspects 17 through 20, further comprising: receiving an indication of a timing threshold, the handover command being received based at least in part on a time duration associated with the UE remaining within the coverage area supported by the first cell satisfying the timing threshold.
Aspect 22: The method of aspect 21, wherein the time duration associated with the UE remaining within the coverage area supported by the first cell is based at least in part on location information of the UE, an ephemeris of a satellite associated with of the first cell, a reference location of the first cell, a radius of the first cell, the coverage information, or any combination thereof.
Aspect 23: The method of any of aspects 17 through 22, wherein the handover command is received based at least in part on a first time duration associated with the UE being within the coverage area supported by the first cell being larger than a second time duration associated with UE characteristics for the measurement-based handover.
Aspect 24: The method of aspect 23, wherein the second time duration associated with the UE characteristics is based at least in part on a quantity or a characteristic of antennas of the UE, a round-trip-time between the UE and the first cell or a second cell associated with the handover command, or any combination thereof.
Aspect 25: The method of any of aspects 17 through 24, further comprising: receiving an indication of one or more parameters associated with the measurement-based handover, the handover command being received based at least in part on a first time duration associated with the UE being within the coverage area supported by the first cell being larger than a second time duration associated with the UE performing the measurement-based handover, the second time duration based at least in part on any combination of the one or more parameters associated with the measurement-based handover or UE characteristics associated with the measurement-based handover, or both.
Aspect 26: A method for wireless communications at a network device, comprising: outputting an indication of coverage information for a first cell associated with a non-terrestrial network, the coverage information indicating a coverage area supported by the first cell for wireless communications; and monitoring for a message indicating a timing information associated with a measurement-based handover from the first cell to a second cell associated with the non-terrestrial network.
Aspect 27: The method of aspect 26, wherein monitoring for the message comprises: obtaining the message indicating the timing information associated with the measurement-based handover from the first cell to the second cell associated with the non-terrestrial network.
Aspect 28: The method of aspect 27, further comprising: outputting, in response to the message that indicates the timing information, control signaling associated with a non-measurement-based handover from the first cell to the second cell.
Aspect 29: The method of any of aspects 27 through 28, further comprising: outputting a configuration for transmitting the message indicating the timing information, the message indicating the timing information being received based at least in part on the configuration.
Aspect 30: The method of aspect 29, wherein the configuration is associated with one of a satellite type or a non-terrestrial cell type of the first cell or the second cell, or both.
Aspect 31: The method of any of aspects 27 through 30, further comprising: outputting an indication of a timing threshold, the message indicating that a time duration associated with remaining within the coverage area supported by the first cell fails to satisfy the timing threshold.
Aspect 32: The method of any of aspects 27 through 31, wherein the message indicates that a first time duration associated with being within the coverage area supported by the first cell is smaller than a second time duration, the second time duration associated with wireless device characteristics for the measurement-based handover.
Aspect 33: The method of any of aspects 27 through 32, further comprising: outputting an indication of one or more parameters associated with the measurement-based handover, the message indicating that a first time duration associated with being within the coverage area supported by the first cell is smaller than a second time duration associated with a wireless device performing the measurement-based handover, the second time duration being based at least in part on any of the one or more parameters associated with the measurement-based handover, wireless device characteristics associated with the measurement-based handover, or both.
Aspect 34: The method of aspect 33, wherein the one or more parameters associated with the measurement-based handover include a measurement periodicity, a measurement gap repetition period, or both.
Aspect 35: The method of any of aspects 27 through 34, wherein the message indicates a recommendation for the measurement-based handover or a non-measurement-based handover, that a wireless device cannot complete the measurement-based handover prior leaving the coverage area of the first cell, an estimated time duration associated with the wireless device remaining in the coverage area of the first cell, a position of the wireless device, or any combination thereof.
Aspect 36: The method of aspect 35, further comprising: outputting a configuration indicating one or more parameters for the timing information or a granularity of the timing information, the timing information being based at least in part on the configuration.
Aspect 37: The method of any of aspects 27 through 36, wherein the message is obtained via a third message or a fifth message of a random access procedure, an uplink message after the random access procedure, a random access preamble, a random access occasion, or any combination thereof.
Aspect 38: The method of any of aspects 27 through 37, wherein the message indicates that a wireless device can perform the measurement-based handover before leaving the coverage area supported by the first cell.
Aspect 39: The method of any of aspects 27 through 38, wherein the message indicates that a wireless device cannot perform the measurement-based handover before leaving the coverage area supported by the first cell.
Aspect 40: The method of any of aspects 26 through 39, further comprising: outputting, after a timing associated with time resources allocated for transmission of an indication of a time estimation associated with a connection between the first cell and a wireless device, a handover command associated with the measurement-based handover for the wireless device.
Aspect 41: The method of any of aspects 26 through 40, wherein the indication of the coverage information is transmitted via a system information block, a Radio Resource Control message, a medium access control message, or any combination thereof.
Aspect 42: The method of any of aspects 26 through 41, further comprising: outputting an indication of one or more parameters to perform a measurement for the measurement-based handover from the first cell to the second cell, the message received in response to the indication of the one or more parameters.
Aspect 43: The method of any of aspects 26 through 42, further comprising: obtaining a second message indicating a recommendation to perform the measurement-based handover or a non-measurement-based handover, an indication of whether the measurement-based handover can be completed prior to a wireless device leaving the coverage area of the first cell, an estimated time duration associated with the wireless device remaining in the coverage area of the first cell, a position of the wireless device, or any combination thereof.
Aspect 44: An apparatus for wireless communications at a UE, comprising a processor; and memory coupled with the processor, the processor configured to perform a method of any of aspects 1 through 16.
Aspect 45: An apparatus for wireless communications at a UE, comprising at least one means for performing a method of any of aspects 1 through 16.
Aspect 46: A non-transitory computer-readable medium storing code for wireless communications at a UE, the code comprising instructions executable by a processor to perform a method of any of aspects 1 through 16.
Aspect 47: An apparatus for wireless communications at a UE, comprising a processor; and memory coupled with the processor, the processor configured to perform a method of any of aspects 17 through 25.
Aspect 48: An apparatus for wireless communications at a UE, comprising at least one means for performing a method of any of aspects 17 through 25.
Aspect 49: A non-transitory computer-readable medium storing code for wireless communications at a UE, the code comprising instructions executable by a processor to perform a method of any of aspects 17 through 25.
Aspect 50: An apparatus for wireless communications at a network device, comprising a processor; and memory coupled with the processor, the processor configured to perform a method of any of aspects 26 through 43.
Aspect 51: An apparatus for wireless communications at a network device, comprising at least one means for performing a method of any of aspects 26 through 43.
Aspect 52: A non-transitory computer-readable medium storing code for wireless communications at a network device, the code comprising instructions executable by a processor to perform a method of any of aspects 26 through 43.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor; and
memory coupled with the processor, the processor configured to:
receive an indication of coverage information for a first cell associated with a non-terrestrial network, the coverage information indicating a coverage area supported by the first cell for wireless communications; and
transmit, based at least in part on location information of the UE and the coverage information, a message indicating a timing information associated with a measurement-based handover for the UE from the first cell to a second cell associated with the non-terrestrial network.

2. The apparatus of claim 1, further comprising:
a transceiver, wherein the processor is further configured to:
receive, via the transceiver and in response to the message indicating the timing information, control signaling associated with a non-measurement-based handover for the UE from the first cell to the second cell.

3. The apparatus of claim 2, wherein the processor is further configured to:
perform the non-measurement-based handover from the first cell to the second cell based at least in part on the control signaling.

4. The apparatus of claim 1, wherein the processor is further configured to:
receive, from the non-terrestrial network, a configuration to transmit the message indicating the timing information, the message indicating the timing information being transmitted in response to the configuration received from the non-terrestrial network.

5. The apparatus of claim 4, wherein the configuration is associated with one of a satellite type or a non-terrestrial cell type of the first cell or the second cell, or both.

6. The apparatus of claim 1, wherein the processor is further configured to:
receive an indication of a timing threshold, the processor being further configured to transmit the message based at least in part on a time duration associated with the UE remaining within the coverage area supported by the first cell failing to satisfy the timing threshold.

7. The apparatus of claim 6, wherein the time duration associated with the UE remaining within the coverage area supported by the first cell is based at least in part on the location information of the UE, an ephemeris of a satellite associated with the first cell, a reference location of the first cell, a radius of the first cell, the coverage information, or any combination thereof.

8. The apparatus of claim 1, wherein processor is further configured to transmit the message based at least in part on a first time duration associated with the UE being within the coverage area supported by the first cell being smaller than a second time duration, the second time duration associated with UE characteristics for the measurement-based handover.

9. The apparatus of claim 8, wherein the second time duration associated with the UE characteristics is based at least in part on a quantity or a characteristic of antennas of the UE, a round-trip-time between the UE and the first cell or the second cell, or any combination thereof.

10. The apparatus of claim 1, wherein the processor is further configured to:
receive an indication of one or more parameters associated with the measurement-based handover for the UE, the processor being further configured to transmit the message based at least in part on a first time duration associated with the UE being within the coverage area supported by the first cell being smaller than a second time duration associated with the UE performing the measurement-based handover, the second time duration being based at least in part on any combination of the one or more parameters associated with the measurement-based handover or UE characteristics associated with the measurement-based handover, or both.

11. The apparatus of claim 10, wherein the one or more parameters associated with the measurement-based handover include a measurement periodicity, a measurement gap repetition period, or both.

12. The apparatus of claim 10, wherein the indication of the one or more parameters is received via a system information block, a Radio Resource Control message, a medium access control message, or any combination thereof.

13. The apparatus of claim 10, wherein the processor is further configured to:
receive an indication of parameters to perform a measurement for the measurement-based handover from the first cell to the second cell, the one or more parameters associated with the measurement-based handover being based at least in part on the parameters to perform the measurement for the measurement-based handover.

14. The apparatus of claim 1, wherein, to transmit the message, the processor is configured to:
transmit the message indicating a recommendation for the UE to perform one of the measurement-based handover or a non-measurement-based handover, whether the UE can complete the measurement-based handover before leaving the coverage area of the first cell, an estimated time duration associated with the UE remaining in the coverage area of the first cell, a position of the UE, or any combination thereof.

15. The apparatus of claim 14, wherein the processor is further configured to:
receive, from the non-terrestrial network, a configuration indicating one or more parameters for the timing information or a granularity of the timing information, the timing information based at least in part on the configuration received from the non-terrestrial network.

16. The apparatus of claim 1, wherein the message is transmitted via a third message or a fifth message of a random access procedure, an uplink message after the random access procedure, a random access preamble, a random access occasion, or any combination thereof.

17. An apparatus for wireless communications at a user equipment (UE), comprising:
a processor; and
memory coupled with the processor, the processor configured to:
receive an indication of coverage information for a first cell associated with a non-terrestrial network, the coverage information indicating a coverage area supported by the first cell for wireless communications; and
receive, after a timing associated with time resources allocated for transmission of an indication of a time estimation associated with a connection between the first cell and the UE, a handover command associated with a measurement-based handover for the UE.

18. The apparatus of claim 17, wherein the processor is further configured to:
transmit, based at least in part on location information of the UE and the coverage information, a message indicating timing information associated with the measurement-based handover from the first cell to a second cell associated with the non-terrestrial network.

19. The apparatus of claim 18, wherein the message indicates that the UE can perform the measurement-based handover before leaving the coverage area supported by the first cell.

20. The apparatus of claim 17, wherein the processor is further configured to:
perform the measurement-based handover from the first cell to a second cell based at least in part on the handover command.

21. The apparatus of claim 17, wherein the processor is further configured to:
receive an indication of a timing threshold, the processor being further configured to receive the handover command based at least in part on a time duration associated with the UE remaining within the coverage area supported by the first cell satisfying the timing threshold.

22. The apparatus of claim 17, wherein the processor is further configured to:
receive an indication of one or more parameters associated with the measurement-based handover, the processor further being configured to receive the handover command based at least in part on a first time duration associated with the UE being within the coverage area supported by the first cell being larger than a second time duration associated with the UE performing the measurement-based handover, the second time duration based at least in part on any combination of the one or more parameters associated with the measurement-based handover or UE characteristics associated with the measurement-based handover, or both.

23. An apparatus for wireless communications at a network device, comprising:
a processor; and
memory coupled with the processor, the processor configured to:
output an indication of coverage information for a first cell associated with a non-terrestrial network, the coverage information indicating a coverage area supported by the first cell for wireless communications; and
monitor for a message indicating a timing information associated with a measurement-based handover from the first cell to a second cell associated with the non-terrestrial network.

24. The apparatus of claim 23, wherein, to monitor for the message, the processor is configured to:
obtain the message indicating the timing information associated with the measurement-based handover from the first cell to the second cell associated with the non-terrestrial network.

25. The apparatus of claim 24, wherein the processor is further configured to:
output, in response to the message that indicates the timing information, control signaling associated with a non-measurement-based handover from the first cell to the second cell.

26. The apparatus of claim 24, wherein the processor is further configured to:
output a configuration for transmitting the message indicating the timing information, the message indicating the timing information being received based at least in part on the configuration.

27. The apparatus of claim 24, wherein the processor is further configured to:
output an indication of a timing threshold, the message indicating that a time duration associated with remaining within the coverage area supported by the first cell fails to satisfy the timing threshold.

28. The apparatus of claim 24, wherein the processor is further configured to:
output an indication of one or more parameters associated with the measurement-based handover, the message indicating that a first time duration associated with being within the coverage area supported by the first cell is smaller than a second time duration associated with a wireless device performing the measurement-based handover, the second time duration being based at least in part on any of the one or more parameters associated with the measurement-based handover, wireless device characteristics associated with the measurement-based handover, or both.

29. The apparatus of claim 24, wherein the processor is further configured to:
output a configuration indicating one or more parameters for the timing information or a granularity of the timing information, the timing information being based at least in part on the configuration.

30. A method for wireless communications at a user equipment (UE), comprising:
receiving an indication of coverage information for a first cell associated with a non-terrestrial network, the coverage information indicating a coverage area supported by the first cell for wireless communications; and
transmitting, based at least in part on location information of the UE and the coverage information, a message indicating a timing information associated with a measurement-based handover for the UE from the first cell to a second cell associated with the non-terrestrial network.
